(19) United States
(12) Patent Application Publication
(10) Pub. No.: US 2026/0265642 A1
(43) Pub. Date: Sep. 10, 2026

(54) Candle, Method for Assembling a Candle, a Candle Assembly Apparatus, and a Fuel Element

(71) Applicant: Blazing Brave Pty Ltd, Fairlight (AU)

(72) Inventors: Dean Maroun, Fairlight (AU); Craig Andrews, Kirribilli (AU); Pavel Zocek, Kirribilli (AU)

(21) Appl. No.: 19/663,151

(22) Filed: Apr. 29, 2026

Related U.S. Application Data
(62) Division of application No. 17/469,186, filed on Sep. 8, 2021, now abandoned.
Application No. 17/469,186 is a continuation-in-part of application No. PCT/AU2021/050977, filed on Aug. 25, 2021.

(30) Foreign Application Priority Data
Sep. 8, 2020 (AU) 2020903222
Nov. 13, 2020 (AU) 2020904187
Feb. 4, 2021 (AU) 2021900261
Feb. 17, 2021 (AU) 2021900404

(51) Int. Cl. C11C 5/02; C11C 5/00

(52) U.S. Cl. CPC C11C 5/021; C11C 5/008

(57) ABSTRACT

A fuel element suitable for use in a candle assembly apparatus is described. The fuel element includes one or more surface recesses or portions configured to cooperate with other like fuel elements when stacked one atop another. A candle assembly apparatus is also described, including: a reservoir for holding fuel; a dispenser for cutting and/or feeding one or more fuel elements from the reservoir to an assembly zone to form a fuel stack; a loader for loading a fuel plug and/or a taper into the fuel stack in the assembly zone. Also described is a candle including: one or more fuel elements, including one or more through holes disposed along its length; and one or more scented fuel plugs or tapers disposed in the one or more through holes. Additionally described is a method for building a candle, the method including the steps of: removing one or more fuel elements from a fuel cartridge; mounting one or more fuel plugs or tapers on a taper holder; joining the one or more fuel elements and the fuel plug or taper so that the fuel plug or taper is disposed within the one or more fuel elements.

### CROSS-REFERENCE TO RELATED APPLICATIONS

This application claims priority to, and the benefit of, copending PCT Application No. PCT/AU2021/050977, entitled “A CANDLE, METHOD FOR ASSEMBLING A CANDLE, A CANDLE ASSEMBLY” and filed on Aug. 25, 2021, which claims priority to and the benefit of (i) Australian Provisional Patent Application No. 2020903222, filed Sep. 8, 2020; (ii) Australian Provisional Patent Application No. 2020904187, filed Nov. 13, 2020; (iii) Australian Provisional Patent Application No. 2021900261, filed Feb. 4, 2021; and (iv) Australian Provisional Patent Application No. 2021900404, filed Feb. 17, 2021, each of which is incorporated by reference as if set forth herein in its entirety.

### TECHNICAL FIELD

The present technology relates generally to candles. The present technology also relates generally to candle making apparatus and methods of making candles. In addition, the present technology relates generally to fuel elements and fuel assemblies for feeding candle making apparatus and for use in methods of making candles.

### BACKGROUND

Candles enjoy enduring popularity. This is so, even though newer technologies such as incandescent bulbs, halogen lamps, fluorescent lamps, and LED lamps have been developed to increase the efficiency of delivery of light.

Candles do not merely provide light; the way it is delivered acts on human senses to facilitate different moods. The flickering of light from the wick moves people in different ways and can evoke certain primal feelings, among them: peace, happiness, relaxation, safety, romance and warmth. Candles can also facilitate meditation and solemnity. A flickering LED light, while passably more pleasant than a static LED light, is often described as fake and unsatisfying.

A scent may be added to the fuel so that an additional sense is involved in the experience.

Candles are also very practical, since they can provide light in emergency situations where electrical and battery power is temporarily unavailable.

For these reasons and more, many people enjoy making their own candles.

Candlemaking apparatus are known, but they are messy and time consuming to use. Making a single candle can take hours, since the fuel, in the form of wax flakes, must be very carefully loaded into a melting reservoir portion of the apparatus. Nevertheless, it usually spills around the apparatus, which takes further time to clean up.

Finally, some candle fuel is not clean burning, and/or is scented in a way that they were not expecting; customers like to know the provenance of their products.

The present inventor seeks to provide a candle making apparatus and a method of making a candle, and a fuel element for loading the candle making apparatus which substantially ameliorate one or more of the above mentioned disadvantages and/or which at least provides a useful alternative to known candle making apparatus, methods and fuel.

### Definition

TAPER: throughout this specification and the claims that follow, it is to be understood that the word “taper” takes its plain meaning, which is, a slender candle. It is to be understood that the taper includes a wick which could itself be substantially rigid or flexible, which is combustible, including braided cotton, fabric, wood, bark, skewer, or suitable combustible material.

Fuel plug: throughout this specification and the claims that follow, it is to be understood that the word “scented fuel plug” is to be understood as a fuel element, like a taper, but which may not have a wick disposed in a central axial position thereon.

### SUMMARY

Broadly, the present technology provides a candle building apparatus configured to assemble one or more candles from one or more fuel blocks.

Broadly, the present technology also provides fuel blocks configured for use in a candle building apparatus.

Broadly, the present technology further provides a method of assembling fuel blocks to form a candle.

Broadly, the present technology further provides a method of cutting fuel blocks from a bar to form a candle.

Broadly, the present technology provides an apparatus that cuts and/or dispenses cored fuel blocks from a bar, and inserts a taper in the one or more cores, to form a candle.

Broadly, the present technology additionally provides a method of building a candle with authorised fuel.

Broadly, the present technology additionally provides a candle building apparatus which is configured to build candles only with authorised fuel.

One arrangement of the technology is such that in use a candle building apparatus cuts or assembles one or more cored fuel block elements and loads a taper in the one or more cores to form a scented candle.

One arrangement of one method of the technology is such that a scented candle is formed by a candle building apparatus by inserting one or more scented fuel tapers into one or more recesses in a fuel block.

Broadly speaking the present technology provides a candle builder with a wax reservoir which stacks wax blocks in an assembly and/or delivery area.

Broadly speaking the present technology also provides fuel pucks with mating surfaces which are arranged to form fuel stacks in use to burn as candles.

Broadly speaking the present technology further provides wax cartridges for use in candle building machines.

Broadly speaking the present technology further still provides methods and machines for candle building by cutting cored wax blocks from a wax bar and inserts a taper in the one or more cores.

Broadly speaking the present technology even further still provides methods and machines for candle building by stacking wax pucks transported in a cartridge.

Broadly speaking the present technology even further provides scented tapers of various cross sections to hold wax stacks together.

In accordance with an aspect of the present technology there is provided a portable candle building apparatus.

In one embodiment the portable candle building apparatus includes an onboard power supply.

### Blocks

In accordance with another aspect of the present technology there is provided a fuel element suitable for use in a candle assembly apparatus, the fuel element including one or more embossed surface portions configured to cooperate with other like fuel elements.

### Fuel Cartridge

In accordance with yet another aspect of the present invention there is provided a fuel cartridge for loading into a candle building apparatus.

In accordance with yet another aspect of the present invention there is provided a fuel cartridge for loading into a candle building apparatus, the fuel cartridge including a plurality of wax elements disposed along a longitudinal axis in a hollow container.

In accordance with still another aspect of the present invention there is provided a fuel cartridge for loading into a candle building apparatus, the fuel cartridge including:
one or more wax elements; and
a wrapper disposed substantially around an outer surface of the one or more wax elements.

In accordance with still another aspect of the present invention there is provided a fuel cartridge for loading into a candle building apparatus, the fuel cartridge including: one or more wax elements; and
a coating or strip disposed on at least a portion of an outer surface of the one or more wax elements.

In one embodiment the coating is a readable security coating or strip for authentication of the wax elements.

In one embodiment the one or more wax elements is a stack or a pillar.

In one embodiment each one of the plurality of wax elements includes one or more through apertures extending from one surface to another.

In one embodiment there is provided a connector disposed between the one or more wax elements to facilitate maintaining the stack or pillar arrangement of the wax elements.

In one embodiment the connector is in the form of one or more wax interconnected elements.

In one embodiment the connector is in the form of one or more cardboard tubes.

In one embodiment there are provided one or more cooperating surface portions to facilitate fastening therebetween.

In one embodiment the hollow container is cylindrical.

In one embodiment the hollow container is square, or triangular, rectangular, star-shaped, pentagonal, hexagonal, or other suitable cross section.

In one embodiment a liner is provided in the hollow tube to facilitate ejection or egress of the wax elements.

In one embodiment a closure is provided at a base of the hollow container to close the hollow container for selectable egress of the wax from the hollow container.

In one embodiment the closure includes frangible or weakened elements to inhibit egress of the wax elements until the wax elements are extracted or forced from the hollow container.

In one embodiment there are provided two, three, four, five, six, seven, eight, nine, ten, eleven or twelve or any suitable plurality of fuel elements disposed one atop the other to form the pillar.

In one embodiment the skin includes a packaging layer.

In one embodiment the packaging layer is a cartridge for containing one or more fuel elements.

In one embodiment the packaging layer includes a sleeve for receiving the fuel element.

In one embodiment the packaging layer includes a cardboard tube element for protecting the fuel element from damage and from adjacent fuel elements during transportation.

In one embodiment the skin is scented with a scent.

### Cold Candle Building Apparatus Summary

In accordance with another aspect of the present technology there is provided a candle assembly apparatus including:
one or more reservoirs for holding one or more fuel elements for assembling into a candle;
a dispenser for dispensing one or more fuel elements from the reservoir into an assembly zone to form a candle.

In one embodiment there is provided a loader for loading a scented fuel plug or scented taper into the one or more fuel elements to form the candle.

In accordance with another aspect of the present technology there is provided a candle assembly apparatus including:
a reservoir for holding fuel;
a dispenser for dispensing one or more fuel elements from the reservoir to an assembly zone to form a fuel block.

In one embodiment there is provided a loader for loading a scented fuel plug and/or taper into the fuel stack in the assembly zone to form a candle.

In one embodiment there is provided a housing for housing the reservoir and dispenser.

In one embodiment the loader is disposed in a side wall of the housing.

In one embodiment the assembly zone is disposed in or on the wall of the housing.

In one embodiment the assembly zone includes a recess in the wall of the housing.

In one embodiment the assembly zone includes a dock disposed on the outside of the housing.

In one embodiment the assembly zone includes a dock disposed in the wall of the housing.

### Fuel Elements

In one embodiment the fuel element is a puck.

In one embodiment the fuel element is a solid block.

In one embodiment the fuel element is a selected quantity of wax flake.

In one embodiment the fuel element is a selected quantity of granules.

In one embodiment a portion of the surface includes a skin, band or wrap element for at least partially surrounding the one or more fuel elements.

In one embodiment the fuel element is a filled hollow body, which includes a skin for at least partially surrounding and retaining a selected amount of liquid or solid fuel.

In one embodiment the skin is an organic or plastic element which is combustible.

In one embodiment the embossed surface or skin portions include knurling.

In one embodiment the embossed surface or skin portions include stamped formations extending above the surface or the skin.

In one embodiment the embossed surface or skin portions include moulded formations extending above the surface or the skin.

In one embodiment the embossed surface or skin portions include bosses.

In one embodiment the bosses are small stacks about 1 mm across and about 1 mm or 2 mm high.

In one embodiment the small stacks are arranged in a cooperating formation so that they may alternate with other formations on like stacks.

In one embodiment the surface or skin portions cooperate with like formations by being configured to crush or melt together and form a bond with an adjacent like stack.

In one embodiment the skin is about 0.1 mm thick.

In one embodiment the skin is about 0.2, 0.3, 0.4, 0.5, 0.6, 0.7, 0.8, 0.9 or 1.0 mm thick.

In one embodiment the fuel is oil.

### Wax

In one embodiment the surface is an external face of a solid block of fuel.

In one embodiment the fuel is a wax.

In one embodiment the wax is animal wax, plant-based wax, mineral wax, or synthetic wax.

In one embodiment the fuel has a melting point at between about 30° C. and 150°C.

In one embodiment the fuel is paraffin wax.

In one embodiment the fuel is soy wax.

In one embodiment the fuel is beeswax.

In one embodiment the fuel is tallow wax.

In one embodiment the fuel is a combination of any one or more of soy wax, beeswax, tallow wax and paraffin wax.

In one embodiment the fuel element is a cylindrical block to facilitate ready formation of a pillar candle.

In one embodiment the fuel element is a square prism to facilitate ready formation of a pillar candle.

In one embodiment the fuel element is a rectangular prism to facilitate ready formation of a pillar candle.

In one embodiment the fuel element is a extruded prism with a regular cross section such as for example, a star, pentagon, hexagon, oval, figure of 8, triangle, octagon, heptagon, nonagon, decagon, dodecagon and the like, to facilitate ready formation of a pillar candle.

In one embodiment the fuel element is a pillar to facilitate ready formation of pillars of selected lengths. For example, the pillar may in use be sliced across its section, so that a shorter pillar may be formed.

In one embodiment the fuel element is a transverse slice of a pillar; in other words, a shim or a disc or puck, depending on its cross-section, in order to facilitate the formation of a taller pillar.

In one embodiment the fuel element is about 10 mm high.

In one embodiment the fuel element is about 30 mm across.

In one embodiment the fuel element is about 5 mm, 7 mm, 12 mm, 15 mm, 18 mm, 20 mm, 25 mm, 30 mm, 35 mm, 40 mm, 50 mm, 60 mm, 75 mm, 80 mm, 90 mm, 100 mm, 125 mm, or 150 mm high.

In one embodiment the fuel element is about 20 mm, 25 mm, 35 mm, 40 mm, 45 mm, 50 mm, 55 mm, 60 mm, 75 mm, 80 mm, 90 mm, or 100 mm across.

In one embodiment the fuel element includes one or more through holes from top to bottom, to facilitate the insertion of a taper into the fuel element.

In one embodiment the one or more through holes are circular.

In one embodiment the one or more through holes are of square, rectangular, star, pentagonal, hexagonal, oval, triangular, octagonal or other suitable cross section.

In one embodiment the one or more through holes are about 5 mm, 6 mm, 7 mm, 8 mm, 9 mm, 10 mm, 11m, 12 mm, 13 mm, 14 mm, 15 mm, 17 mm, 20 mm or 25 mm across or any suitable cross-sectional distance or diameter to receive a taper.

### Scented Fuel Plug and Taper

In one embodiment the scented fuel plug is a scented fuel element, with the same features of shape as the taper described herein, but without a wick.

In one embodiment the taper includes a wick embedded in taper wax.

In one embodiment the scented fuel plug, or the taper wax, includes a scent.

In one embodiment the scented fuel plug, or the taper wax scent includes essential oil.

In one embodiment the scented fuel plug, or the taper wax scent includes mint leaves, cinnamon, bergamot, nutmeg, or other natural plant substances.

In one embodiment the scented fuel plug, or the taper wax scent includes synthetic scents.

In one embodiment the scented fuel plug, or the taper wax and/or fuel wax includes disinfectant, antibacterial and/or antiviral ingredients.

In one embodiment the scented fuel plug, or the taper is a stack.

In one embodiment the scented fuel plug, or the taper, is about 5 mm across, to fit into the through hole.

In one embodiment the taper is about 8 mm, 9 mm, 10 mm, 11 mm, 12 mm, 13 mm, mm, 15 mm, 16 mm, 17 mm, 18 mm, 19 mm, 20 mm, 25 mm, 30 mm, or 35 mm across.

In one embodiment the scented fuel plug, or the taper, is dimensioned to fit in the through hole.

In one embodiment the scented fuel plug, or the taper, is slightly tapered along its length to minimise friction during loading into the through hole.

In one embodiment the scented fuel plug, or the taper, is configured to cooperate with the shape of the bore in the fuel block.

In one embodiment the scented fuel plug, or the taper, is star-shaped in section.

In one embodiment the scented fuel plug, or the taper, is circular in section.

In one embodiment the scented fuel plug, or the taper, is square in section.

In one embodiment the scented fuel plug, or the taper, is triangular in section.

In one embodiment the scented fuel plug, or the taper, is kidney-shaped in section.

In one embodiment the reservoir is configured to receive and temporarily hold one or more fuel elements.

In one embodiment the reservoir includes at least one hollow tube of a cross sectional dimension and shape which cooperates with that of the one or more fuel elements.

In one embodiment the reservoir includes two, three or four hollow tubes of a cross section dimension and shape which cooperates with that of the one or more fuel elements.

In one embodiment the one or more hollow tubes of the reservoir is configured to receive a fuel pillar.

In one embodiment the one or more hollow tubes of the reservoir is configured to receive a fuel cartridge.

### Fuel Magazine

In accordance with a further aspect of the present invention there is provided a fuel magazine for use in a candle building apparatus, the fuel magazine including: a frame for holding one or more fuel pillars or cartridges.

In one embodiment the fuel pillars or cartridges include a plurality of fuel elements stacked one atop the other.

In one embodiment the fuel magazine includes a biasing element to push the one or more fuel elements from the cartridge.

In one embodiment the reservoir includes a fuel magazine which includes more than one hollow tube for receiving more than one fuel pillar or cartridge.

In one embodiment the fuel magazine includes three hollow tubes.

In one embodiment the fuel magazine includes a frame which is configured to receive three fuel cartridges or pillars.

In one embodiment the fuel magazine is configured to operatively mount into the reservoir for selective opening of a fuel cartridge to the dispenser.

In one embodiment the fuel magazine is configured to include a closure to control access to the one or more hollow tubes.

In one embodiment the loader is configured to load the taper into the fuel stack.

In one embodiment the loader includes a holder for holding the taper.

In one embodiment the loader includes a drawer for transporting the taper to the assembly zone.

In one embodiment the loader includes a drive for driving the taper into the fuel stack.

In one embodiment the drive includes a die for locating the taper into the fuel stack.

In one embodiment the die includes a recess for retaining the taper.

In one embodiment the drive includes a clamp for locating the taper while it is driven into the fuel stack.

In one embodiment the die includes a portion for driving the one or more fuel elements together to form a pillar candle monolith.

In one embodiment the assembly zone includes a loading zone at an entrance thereof, for loading a candle container.

In one embodiment the loading zone includes a door for controlling access to the assembly zone.

In one embodiment the loading zone includes a drawer to assist in transporting the container to the assembly zone.

In one embodiment the loading zone includes an access controller for inhibiting access to unauthorised containers.

In one embodiment the access controller includes an interlock so that only authorised containers are allowed through into the assembly zone.

In one embodiment the access controller inhibits operation of the candle assembly until the reader reads an authorised message on a security tag.

In one embodiment the access controller includes a recess of a selected dimension to cooperate with a key or other projection on a container.

In one embodiment the access controller includes a reader to read a security tag on the container.

In one embodiment there is also provided a magazine access controller which includes similar features to those of the loading zone access controller.

In one embodiment the access controller includes a reader to read a security tag on the taper, fuel cartridge or fuel pillar.

In one embodiment the access controller and/or magazine access controller includes an optical reader to read a barcode on the magazine, taper, fuel cartridge or container.

In one embodiment the readable, scannable coating, code, RFID chip, barcode is coated on or stamped into the taper or fuel.

In one embodiment the security code is printed onto the taper and/or fuel cartridge.

In one embodiment the fuel magazine is configured to removably mount to the reservoir to facilitate ease of filling and refilling the magazine with fuel cartridges.

In one embodiment the apparatus is configured to receive fuel into an inlet of the reservoir, the fuel being in the form of one or more fuel elements as above described.

### Reservoir

In one embodiment the reservoir includes an inlet and an outlet for fuel.

In one embodiment the reservoir outlet is connected to an inlet of the dispenser for transferring one or more fuel elements thereto.

In one embodiment the dispenser includes an inlet closure for selectively inhibiting access of fuel elements from the reservoir.

In one embodiment the dispenser includes an outlet for transporting the fuel elements from the reservoir to the assembly zone.

In one embodiment the dispenser includes an outlet closure for selectively controlling access of the fuel elements to the assembly zone.

In one embodiment the dispenser includes a selector for selecting a particular one or more fuel elements from selected hollow tubes.

In one embodiment the selector is a rotating transporter which includes one or more recesses cooperating in cross section with the fuel elements for receiving fuel elements for loading into the assembly zone.

In one embodiment the rotating transporter is a turntable wherein the one or more recesses are disposed on a rotating disc.

In one embodiment the rotating transporter is an arm rotatably connected to a hub with a holder at a distal part of the arm.

In one embodiment the selector is a drive for rotating the magazine which can align the reservoir outlet with the dispenser inlet for transport to the assembly zone.

In one embodiment the dispenser includes a cutter for cutting a fuel element from the fuel cartridge.

In one embodiment the cutter includes a line cutter.

In one embodiment the line is metal.

In one embodiment the line cutter includes a carriage for carrying an end of the line around a track for cutting the fuel element.

In one embodiment the cutter includes a knife.

In one embodiment knife is rotatably mounted adjacent the dispenser.

In one embodiment there is provided a heater for heating the knife or line.

In one embodiment the heater includes an electric current generator for connecting to the line or knife.

### Housing

In one embodiment the assembly apparatus includes a housing for protecting the components and protecting the user from the components.

In one embodiment the housing includes a closure for controlling access to the reservoir for loading fuel.

In one embodiment the closure is a lid on a top of the housing.

In one embodiment the housing includes a loading drawer for loading a taper.

In one embodiment the housing includes an assembly zone for assembling the fuel blocks, and/or assembling the taper into the one or more fuel blocks.

In one embodiment an assembly zone loading drawer is provided for loading a container into the housing to receive the one or more fuel blocks and taper.

In one embodiment the housing includes a user interface for actuating the building process.

In one embodiment the user interface includes an actuator which causes the building process to commence.

In one embodiment the actuator is a button for simplicity of use.

In one embodiment there is provided a control system on board the housing.

In one embodiment the control system includes a processor for controlling the assembly.

In one embodiment the onboard processor is configured to commence building a candle of a selected height depending on the length of the press of the button.

In one embodiment the onboard processor is configured to implement the assembly of a candle of a low height (two fuel elements) if the button is pressed once, and of a medium height (three fuel elements) if the button is pressed two times, and of a tall height (four fuel elements) if the button is pressed three times.

In one embodiment the control system includes a wireless module for wireless communication with a mobile device for configuration.

### Computer Controlled Method of Candle Building

In accordance with a still yet further aspect of the present technology there is provided a computer implemented control method for assembling a candle in a candle assembly apparatus, the method including the steps of:
receiving data relating to a press from a user button or an assembly zone activity;
initiating a dispense command to a dispenser to dispense a fuel block from a fuel reservoir into the assembly zone;
initiating a press command to a press to press a taper into the fuel block.

In accordance with one aspect of the present technology there is provided a system for configuring a candle assembly apparatus, the system including:
a candle assembly apparatus which includes a user interface comprising a button actuator;
an onboard computer processor and network card for communicating with a mobile device.

In accordance with one aspect of the present technology there is provided a container for a candle which is configured to cooperate with an access controller for a loading zone.

In accordance with one aspect of the present technology there is provided a candle assembly apparatus which includes an access controller including a reader for reading a bar code on a fuel cartridge to control access to the apparatus.

In accordance with still another aspect of the present technology there is provided a scented wax taper, including a plurality of scent zones wherein different or complementary scents are infused in the wax of each scent zone.

### Heating Unit

In one embodiment the fuel dispenser and/or reservoir includes a heating unit for heating the fuel in the reservoir for dispensing fuel into the container.

In one embodiment the heating unit heats the fuel until it softens.

In one embodiment there is provided a heating unit for heating the fuel and/or the taper.

In one embodiment there is provided a refill module for holding a plurality of candles for delivery to the assembly zone.

In one embodiment the refill module includes a frame for mounting a plurality of candles.

In one embodiment the heating unit includes a heating probe for heating an interior of a fuel element.

In one embodiment the heating unit includes a heating sleeve to heat an exterior of a fuel element or taper.

### Container

In one embodiment the containers are formed from glass, plastic, or recycled husks.

As shown in FIG. 68, the container 23 includes a match strike surface such as for example flint 81 for lighting a match. The container 23 also includes a stand 83 for holding the container 23 at an elevated position above a surface for cooling the container 23.

In FIG. 72 it can be seen that at the base of the container is a formation 84 for interlocking with a cooperating formation 184 (FIG. 73) in the assembly zone 40. The formation includes a plurality of lugs 67.

### Candle Dispensing Kiosk

In accordance with still another aspect of the present technology there is provided a vending machine configured to assemble candles from wax discs.

In one embodiment the candle assembly apparatus is as described above and below, in the form of a vending machine.

In accordance with a still further aspect of the present technology there is provided a vending machine configured to make candles from wax.

In accordance with a yet further aspect of the present technology there is provided a vending machine configured to pour candle wax into containers to form candles.

In accordance with a yet further aspect of the present technology there is provided a vending machine configured to dispense candles.

In accordance with a further aspect of the present technology there is provided a vending machine configured to dispense candles, the vending machine including:
a candle dispensing zone.

In one embodiment the vending machine further includes a candle building assembly for building candles.

In one embodiment the candle building assembly includes an assembly zone as herein described.

In one embodiment the candle assembly zone includes a loader for loading a scented taper into a fuel stack.

In one embodiment there is provided a method of vending a candle, the method including the steps of:
dispensing fuel from a fuel cartridge into an assembly zone;
connecting or otherwise engaging a taper with the fuel so that the taper is disposed within the fuel.

In one embodiment the assembly zone includes a closure for controlling access to the assembly zone.

In one embodiment the closure includes a sliding door.

In one embodiment the closure includes a hinged door.

In one embodiment the closure includes a door which moves transversely forward so as to eject the container and candle from the assembly zone, and moved transversely rearward to open the assembly zone for access to the candle.

In one embodiment the vending machine includes a sensor for sensing a user.

In one embodiment the sensor includes a camera.

In one embodiment the sensor includes a wireless module for detecting wireless signals.

In one embodiment the wireless module includes a Bluetooth module.

In one embodiment the vending machine includes a credit card reader.

In one embodiment the vending machine includes a numeric keypad.

In accordance with another aspect of the present invention there is provided a kiosk for dispensing a candle, the kiosk including:
a housing with a user interface thereon for operating the kiosk;
a reservoir for receiving fuel;
an assembly zone for assembling the candle;
a fuel dispenser connected to the reservoir for dispensing fuel into a container disposed in the assembly zone.

In one embodiment the fuel dispenser and/or reservoir includes a heating unit for heating the fuel in the reservoir for dispensing fuel into the container.

In one embodiment the heating unit heats the fuel until it softens.

In one embodiment the heating unit heats the fuel until it is pourable.

In one embodiment there is provided a heating unit for heating the fuel and/or the taper.

In one embodiment there is provided a refill module for holding a plurality of candles for delivery to the assembly zone.

In one embodiment the refill module includes a frame for mounting a plurality of candles.

In one embodiment the heating unit includes a heating probe for heating an interior of a fuel element.

In one embodiment the heating unit includes a heating sleeve to heat an exterior of a fuel element or taper.

In one embodiment the loader for loading a scented taper into the fuel.

### Candle Dispensing Method

In accordance with a yet further aspect of the present invention there is provided a computer controlled method of dispensing a candle, the method including the steps of: receiving data in a computer processor relating to the presence of a container in a container dock; actuating a wax filling module to fill the container with wax.

In one embodiment the data relating to the presence of the container includes container size data.

In one embodiment the wax filling module includes a wax puck dispenser.

In one embodiment the wax puck dispenser dispenses pucks in a stack in the container.

In one embodiment the wax filing module includes a heater and a liquid wax pouring apparatus.

In one embodiment the method includes the step of loading a taper into the wax pucks.

In one embodiment the method includes the step of reading a code on the container to provide container data to the computer processor.

In one embodiment the method further includes the step of dispensing a lid onto the container.

In one embodiment the method further includes the step of cooling the container.

### Reader

In one embodiment the method includes the step of recording the quantity of wax dispensed by the dispenser.

In one embodiment the method further includes the step of notifying the user when the wax reservoir is low on fuel.

### Sampling Module

In accordance with another aspect of the present invention there is provided a scent sampling module for dispensing sample scents, the apparatus including:
a sample receiving dock for receiving a sample fuel element;
a heating unit disposed in the dock for heating the sample fuel element.

In one embodiment the sample receiving dock is disposed on a landing body.

In one embodiment the dock is disposed on a distal end of the landing body.

In one embodiment the landing body is extendable from a candle building housing.

In one embodiment the landing body is extendable from a candle building kiosk housing.

In one embodiment the sampling module is a drawer that slides out from the candle building housing.

In one embodiment the sampling module is a drawer that swings out from the candle building housing.

In one embodiment the sampling module is a hinged door that pivots out from the candle building housing.

In one embodiment the sampling module includes a lock that retains the drawer or door in the housing.

In one embodiment the sampling module includes a release actuator to release the lock.

In one embodiment the dock includes a button receiver for receiving a button of wax for heating.

In one embodiment the dock includes a button mount for mounting a button of wax for heating.

In one embodiment the dock is disposed in the candle building housing.

In one embodiment there is provided a dock closure.

In one embodiment the dock is disposed adjacent the fuel reservoir under the lid of the candle building housing.

### Sample

In accordance with one aspect of the present technology there is provided a scent sample kit including a tray of scented wax buttons disposed thereon.

In accordance with one aspect of the present technology there is provided a scent sample kit including a packet of buttons for mounting in the dock.

In one embodiment there is provided a wallet of scent samples, the wallet including:
a housing for receiving a plurality of scent sample packets, and
an access opening for removing one scent sample packet from the wallet.

### Access Control Module

In one embodiment there is provided an access control module which includes a reader for reading an authenticator element on a scented taper or a fuel cartridge or a container.

In one embodiment the reader reads a security coating.

In accordance with another aspect of the present technology there is provided a candle including:
one or more fuel elements, including one or more through holes disposed along its length; and
one or more scented tapers disposed in the one or more through holes.

The arrangement is such that when there is provided more than one fuel element, one is disposed atop another so as to form a fuel stack, with the scented taper disposed in the through hole and passing from a base fuel element to a top fuel element.

In one embodiment there are provided two or more through holes extending through the fuel elements.

In one embodiment there are provided three through holes extending through the fuel elements.

In one embodiment there are provided four through holes extending through the fuel elements.

In one embodiment the candle includes a container for receiving and supporting the one or more fuel elements.

In one embodiment the container includes a glass with one or more walls surrounding a void for receiving the one or more fuel elements, an open top and a base.

In one embodiment the container includes a closure to inhibit the top of the taper coming into contact with the one or more fuel elements during combustion.

In one embodiment the closure is configured to be disposed on the open top.

In one embodiment the closure includes a seal for sealing the open top to inhibit fuel release from the container.

### Method of Cold Building a Candle

In accordance with another aspect of the present technology there is provided a method for building a candle, the method including the steps of:
dispensing one or more fuel elements from a fuel cartridge to form a fuel stack;
inserting one or more more fuel plugs or tapers into the fuel stack so that the one or more tapers is substantially in contact with the fuel stack.

In one embodiment the one or more fuel elements include one or more bores for receiving at least a portion of a fuel plugs or taper.

In one embodiment the method includes the step of mounting the one or more tapers onto a fuel plug or taper loader.

In one embodiment the method includes the step of pressing the fuel stack together so that the one or more fuel elements in the fuel stack are substantially in contact with adjacent fuel elements.

In one embodiment the method includes the step of receiving in an assembly zone of a candle building housing a container for receiving the fuel stack.

In one embodiment the method includes the step of dispensing the one or more fuel elements into a container.

In one embodiment the method includes the step of heating the fuel stack to slightly melt at least a portion of one or more of the fuel elements together to reduce the air gap between each fuel block.

In one embodiment the method includes the step of heating an inner surface of the bore to facilitate good contact between the taper and the fuel stack.

In one embodiment the method includes the step of inserting a heated probe into the fuel stack.

In one embodiment the method includes the step of inserting a heated probe into the one or more bores of the fuel stack to facilitate good contact between the taper and the fuel stack.

In one embodiment a press is provided which is manually operated.

### Cold Pressing a Candle—a Kit, a Manual Tool and a Method

In accordance with a yet further aspect of the present invention there is provided a method for building a candle, the method including the steps of:
dispensing one or more wax elements, each wax element having at least one through bore, to form a fuel stack with at least one bore;
driving a fuel plug or taper into the fuel stack with a tamper so that the fuel plugs or taper is substantially in contact with the bore in the fuel stack.

In one embodiment the method includes the step of loading a portion of the fuel plug or taper into the tamper for driving into the fuel block.

In accordance with still another aspect of the present invention there is provided a tool for driving a fuel plug or taper into a bore of a wax block, the tool including:
a handle for gripping and operating the tool;
a flange disposed at the base of the handle for pressing down on a wax stack,
wherein the flange includes a recess for receiving a portion of a fuel plug or taper.

In accordance with another aspect of the present invention there is provided an apparatus for driving a taper into a bore of a wax block, the apparatus including:
a frame;
a press mechanism operatively mounted to the frame, the press mechanism including an actuator and a plate for pressing the wax block, the plate including a bore for receiving a portion of a fuel plug or taper.

In accordance with yet another aspect of the present technology there is provided a method for building a candle, the method including the steps of:
dispensing one or more fuel elements from a fuel cartridge to form a fuel pillar;
forming one or more through holes in the one or more fuel elements;
placing one or more fuel plugs or tapers into the one or more holes in the fuel pillar.

In accordance with still another aspect of the present technology there is provided a method for assembling a candle, the method including the steps of:
removing, from a fuel cartridge, one or more fuel elements, having one or more holes disposed therein, to form a fuel pillar;
joining the fuel pillar and a fuel plug or taper so that the fuel plug or taper is disposed within the fuel pillar.

In accordance with a yet further aspect of the present technology there is provided a method for assembling a candle, the method including the steps of:
forming a fuel pillar from one or more fuel elements having one or more holes disposed therein;
joining the fuel pillar and one or more fuel plugs or tapers so that the one or more fuel plugs or taper is disposed within the fuel pillar.

In accordance with a still further aspect of the present technology there is provided a method for assembling a candle, the method including the steps of:
forming a fuel pillar from one or more fuel elements;
pressing the one or more fuel elements together to form a monolith.

In accordance with a yet further aspect of the present invention there is provided a kit of parts for assembling a candle, the kit including:
one or more cored fuel blocks;
one or more fuel plugs or tapers for insertion into the one or more cores in the fuel blocks; and
a tool for driving the one or more fuel plugs or tapers into the one or more cores.

In one embodiment the tool is as herein described.

In one embodiment the kit includes a cutter for cutting the fuel block into a smaller block to reduce the size of the block to match the size of the taper.

### Advantages

Advantageously, embodiments of the present technology provide a way of assembling a candle where one or more scented tapers are placed in a through hole in a pillar of fuel.

During assembly, users are not exposed to heat or pressure, or molten wax, or mess. Assembly time is measured in seconds, rather than hours.

A person could come home from work, select a scented taper, say, lemon myrtle, Port Jackson fig, gardenia, or a blend of two tapers with two or more of these scented units, place it or them in the taper loader, and close the drawer. The user then loads a container, if desired, into the container loading zone, and presses the actuator button. The candle is assembled in a few seconds or a minute or so, and is ready to remove from the assembly zone. The candle is then ready to use.

Users can also have confidence that the fuel they are burning is of a selected quality since in some embodiments the machine checks the barcodes or chips on the fuel fuel and even the container if required. The utility of the container being checked for quality is that the container is less likely to break during heating by the fuel load, and the fingers are unlikely to be burnt, since the container quality control will be carefully monitored.

### Clarifications

In this specification, where a document, act or item of knowledge is referred to or discussed, this reference or discussion is not an admission that the document, act or item of knowledge or any combination thereof was at the priority date:
(a) part of common general knowledge; or
(b) known to be relevant to an attempt to solve any problem with which this specification is concerned.

It is to be noted that, throughout the description and claims of this specification, the word ‘comprise’ and variations of the word, such as ‘comprising’ and ‘comprises’, is not intended to exclude other variants or additional components, integers or steps.

### BRIEF DESCRIPTION OF THE DRAWINGS

In order to enable a clearer understanding, a preferred embodiment of the technology will now be further explained and illustrated by reference to the accompanying drawings, in which:

FIG. 1 is a perspective view of two fuel cartridges, one standing up and one lying prone, as well as five embossed fuel elements, each one having embossed cooperating surfaces for locating with like fuel elements;

FIG. 2 are two section views of candles made by the method and apparatus of embodiments of the present technology;

FIG. 3 is a side perspective view of a candle assembly apparatus, with parts of a housing removed for clarity;

FIG. 4 is a perspective view of a candle assembly apparatus, shown from the front, above and the right hand side, with the taper loading drawer shown in an open position;

FIG. 5 is a perspective view of a candle assembly apparatus, shown from the front, above and the right hand side, with the container loading drawer shown in an open position;

FIG. 6 is a perspective view of a candle assembly apparatus shown from the same angle as FIGS. 4 and 5, but with a fuel cartridge closure shown in an open position;

FIG. 7 is another embodiment of a candle assembly apparatus shown from one side and with housing partially removed for clarity;

FIG. 8 is a detail view of the wick loading drawer of FIGS. 7 and 3 to 5, shown in an open position;

FIG. 9 is a perspective view of the embodiment of assembly apparatus shown in

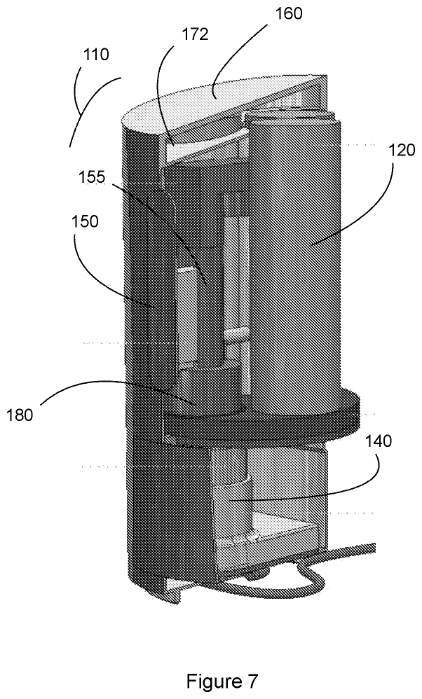

FIG. 7 shown with the container loading drawer in an open position;

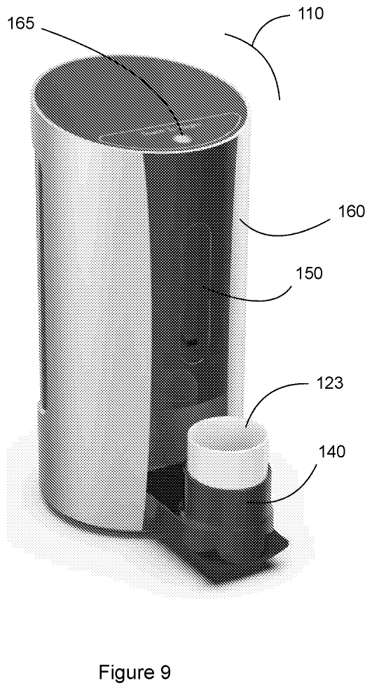

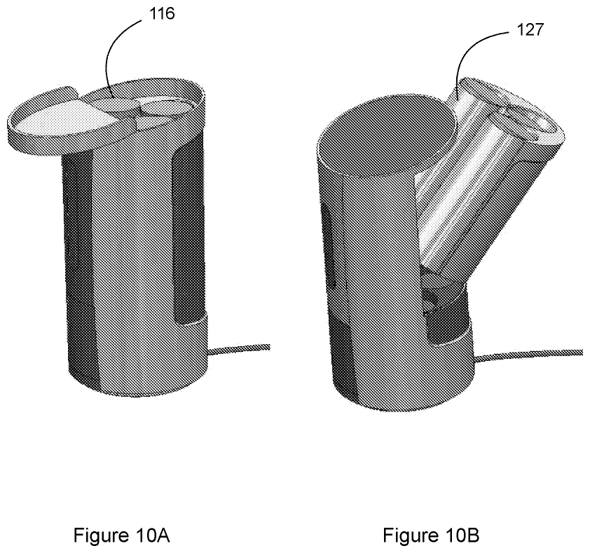

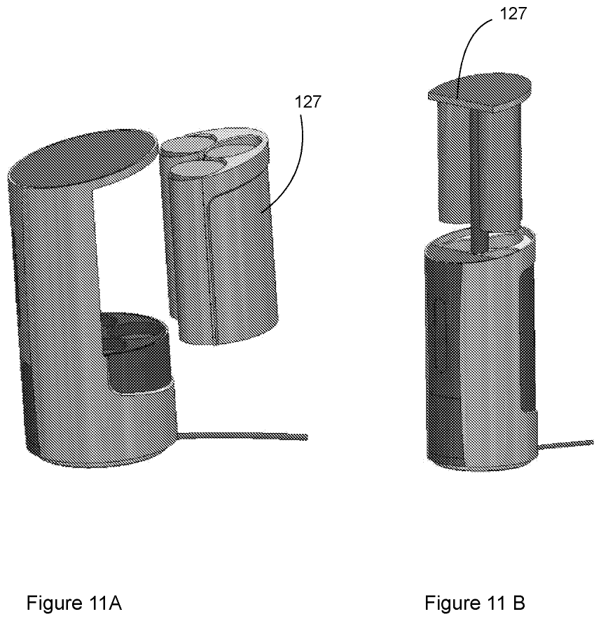

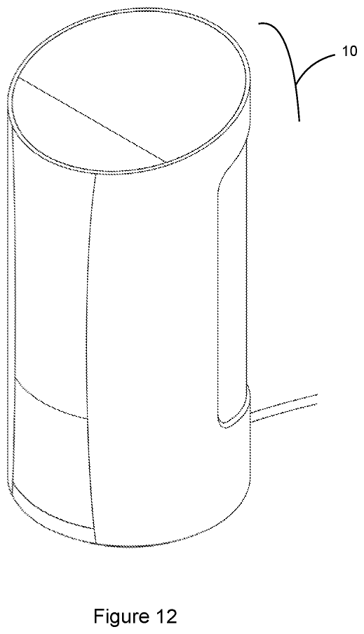

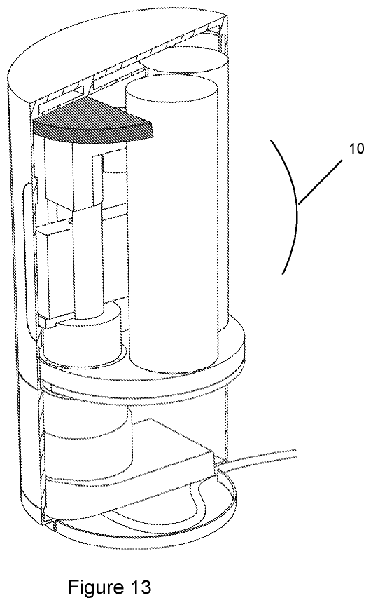

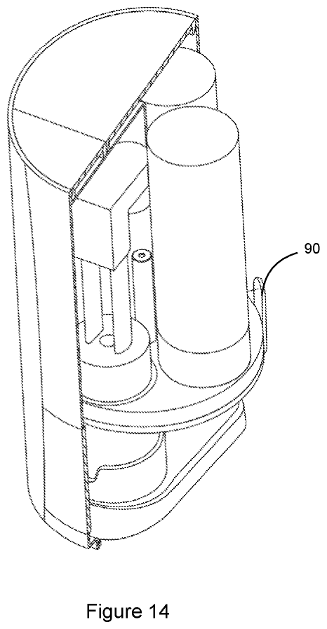

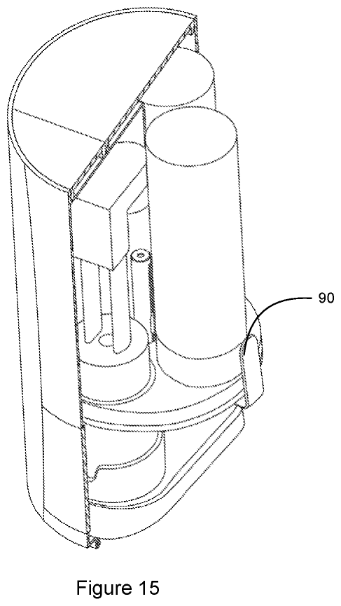

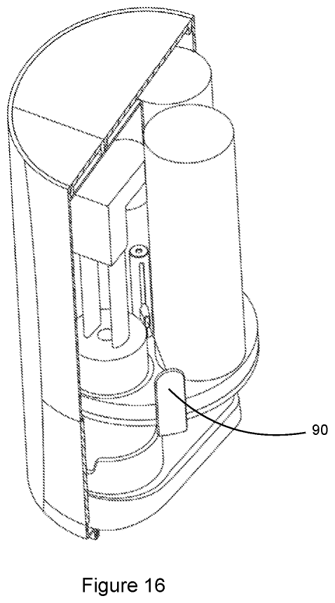

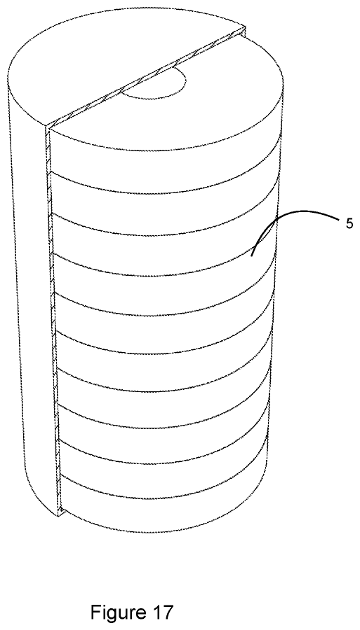

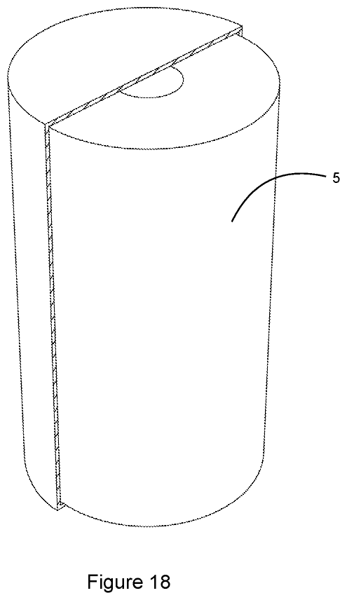

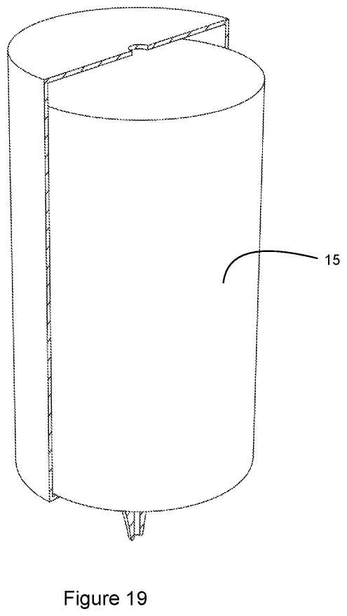

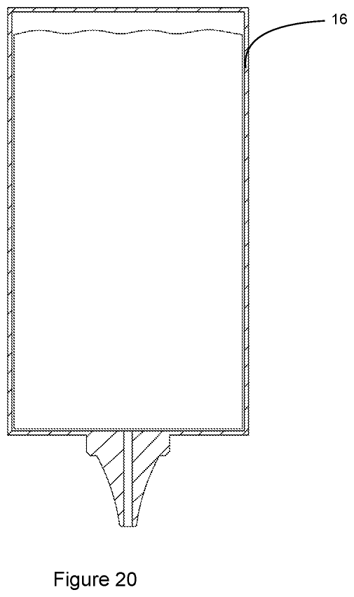

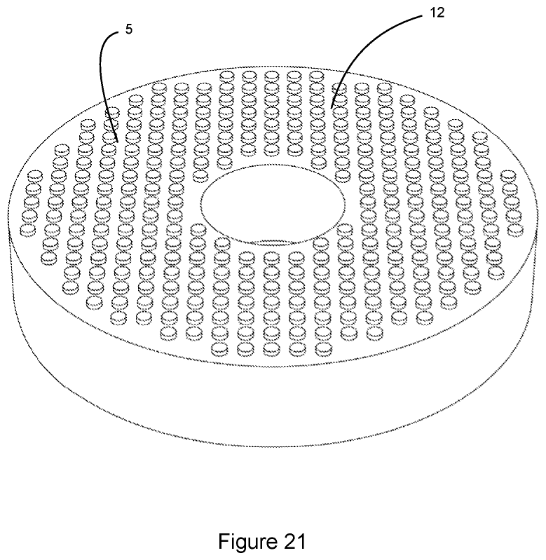

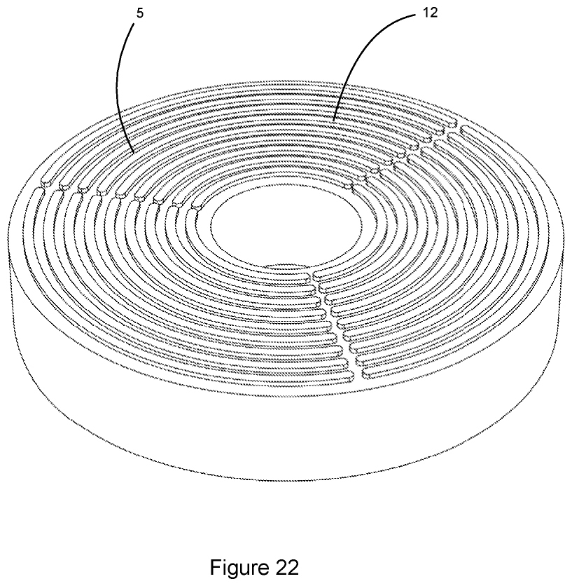

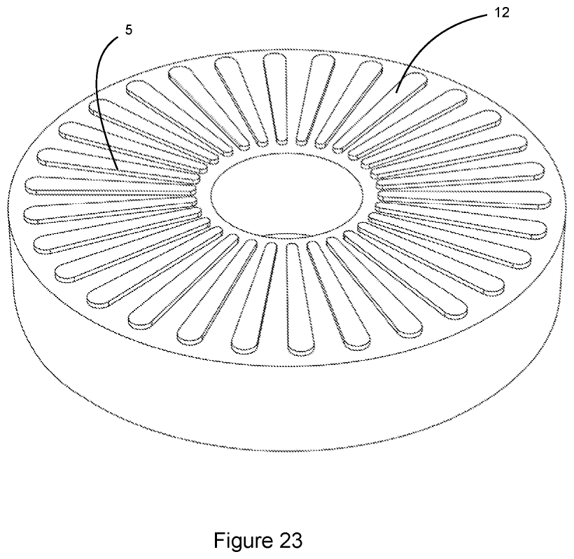

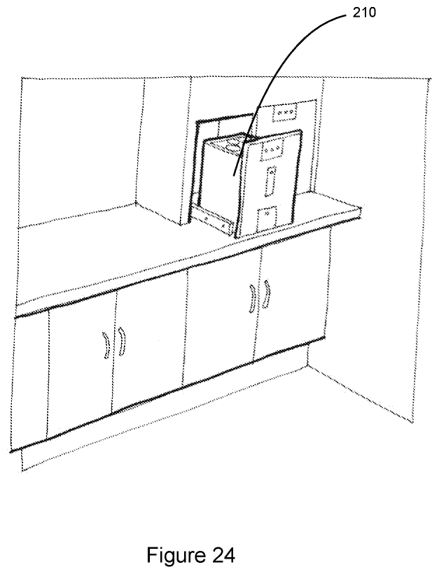

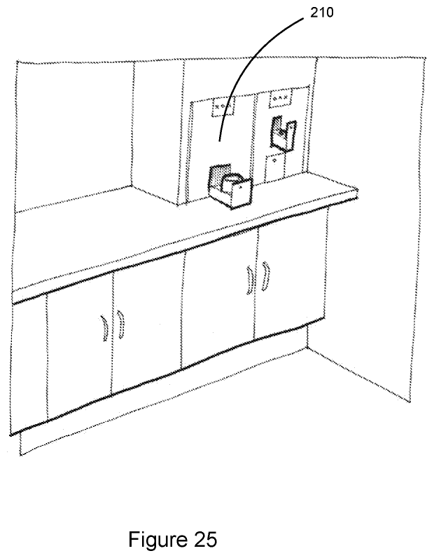

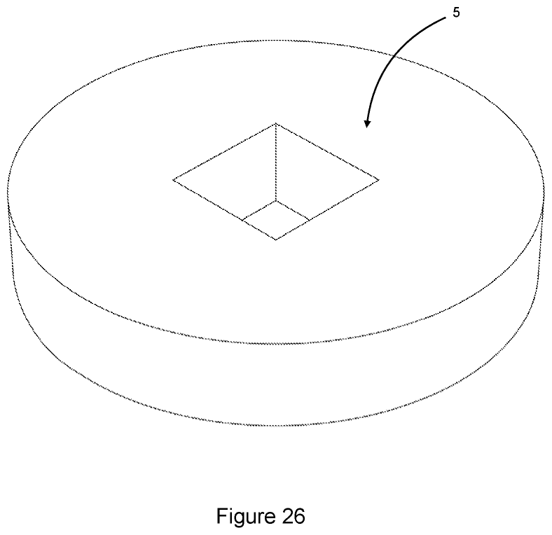

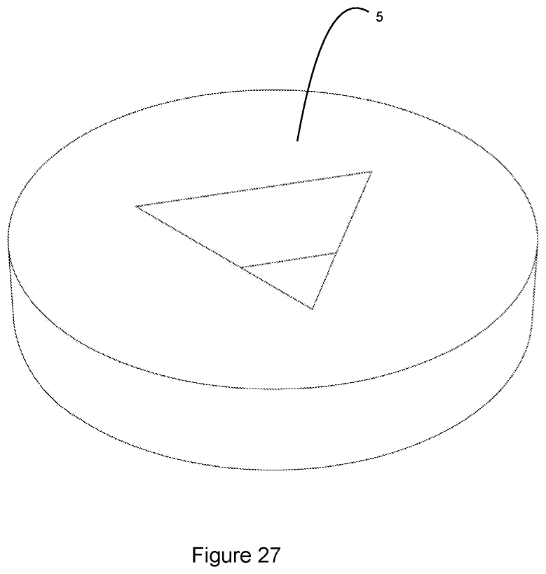

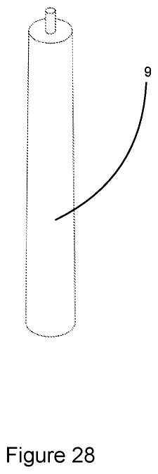

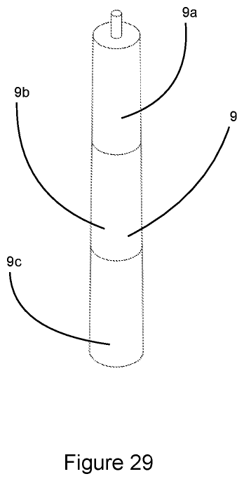

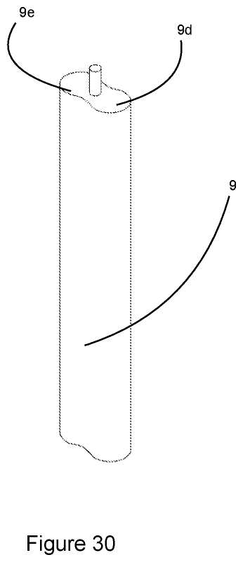

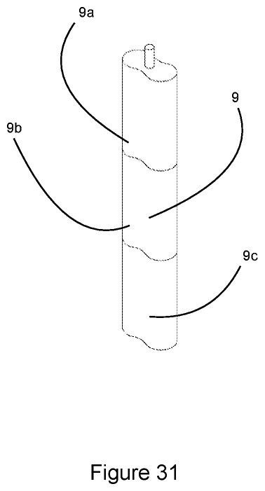

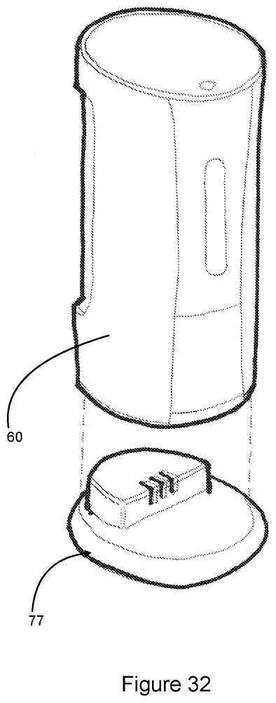

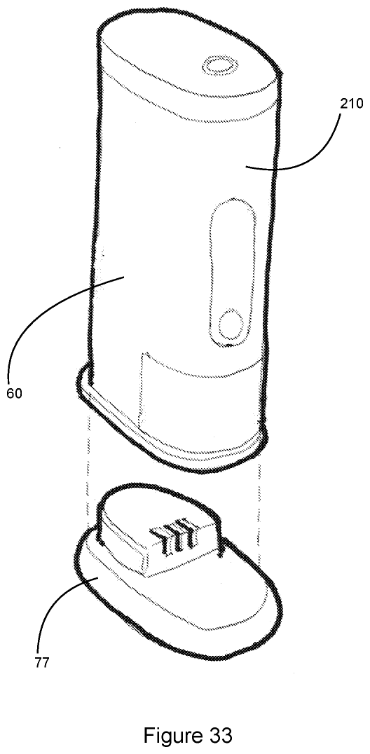

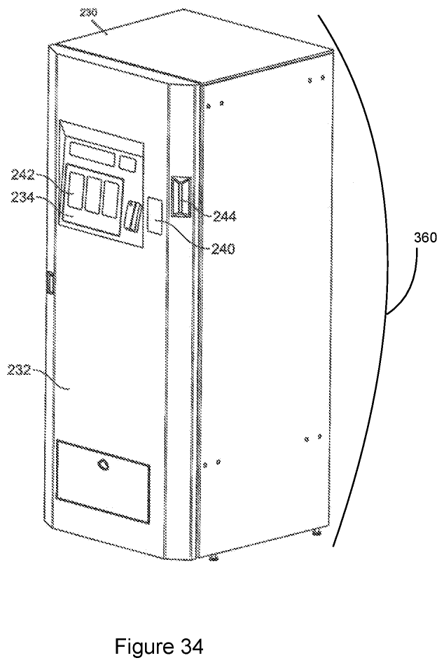

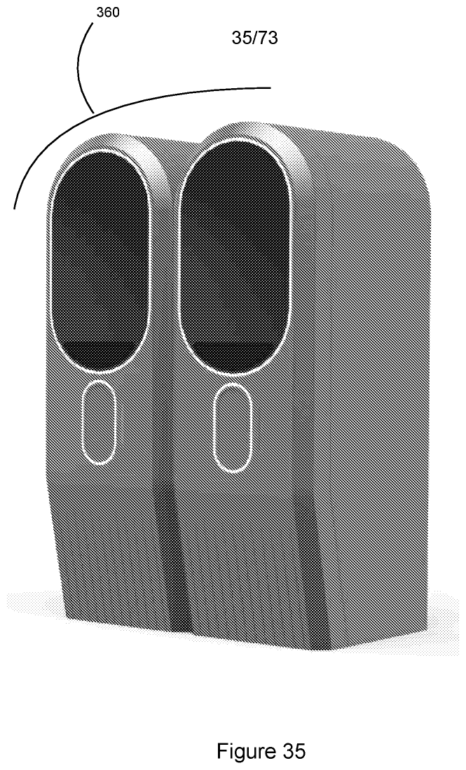

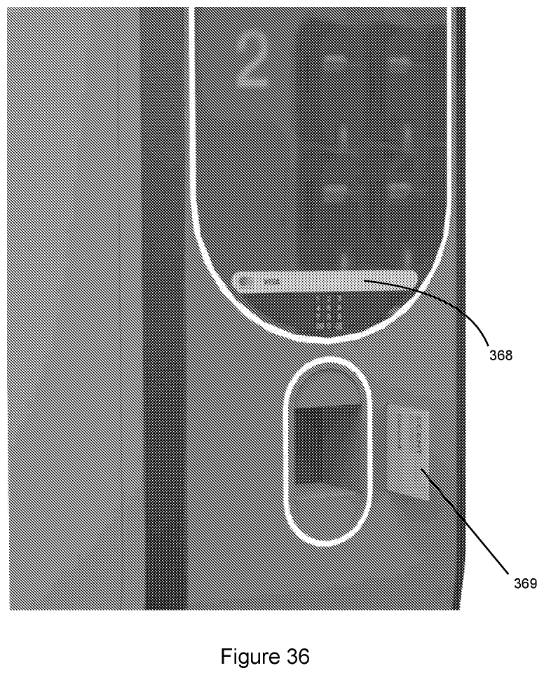

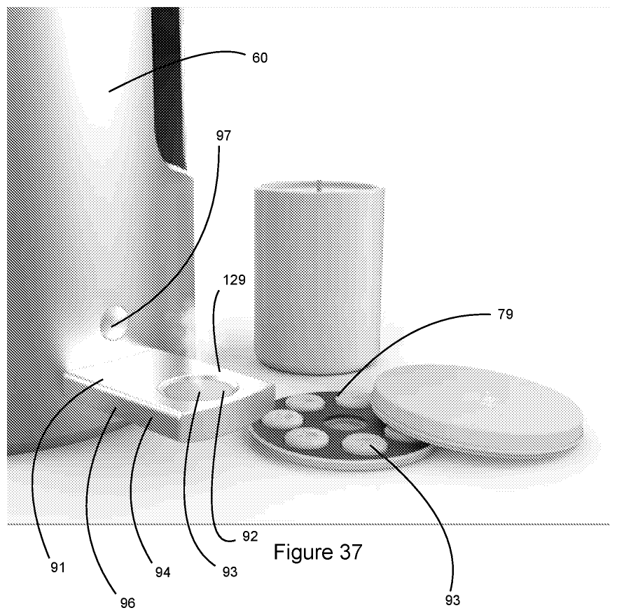

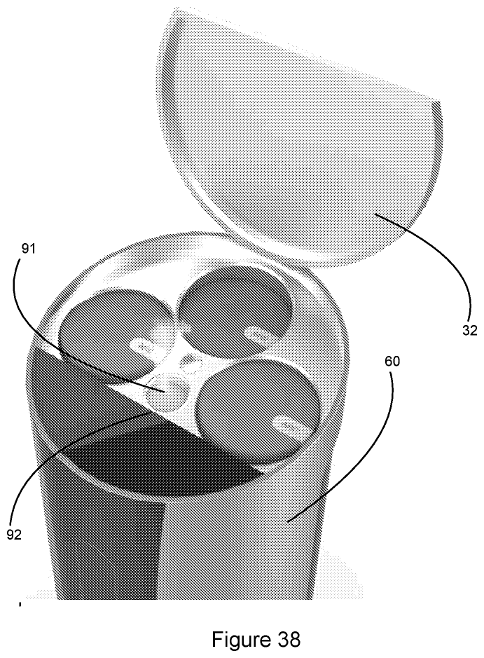

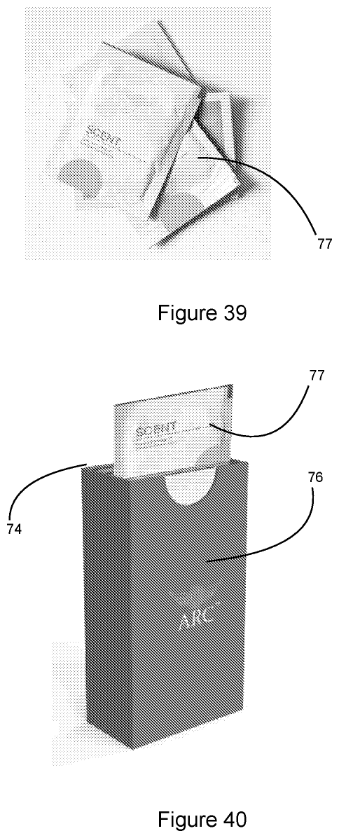

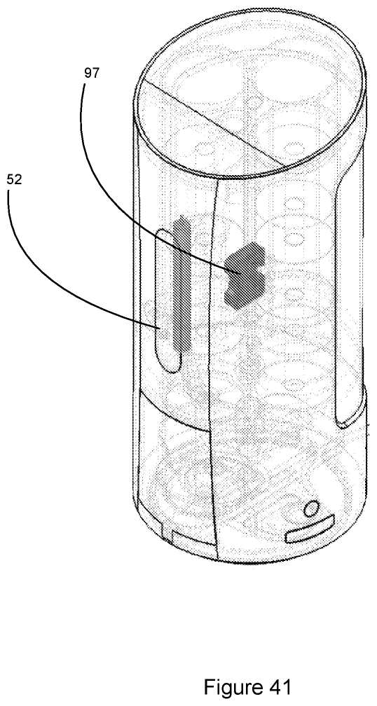

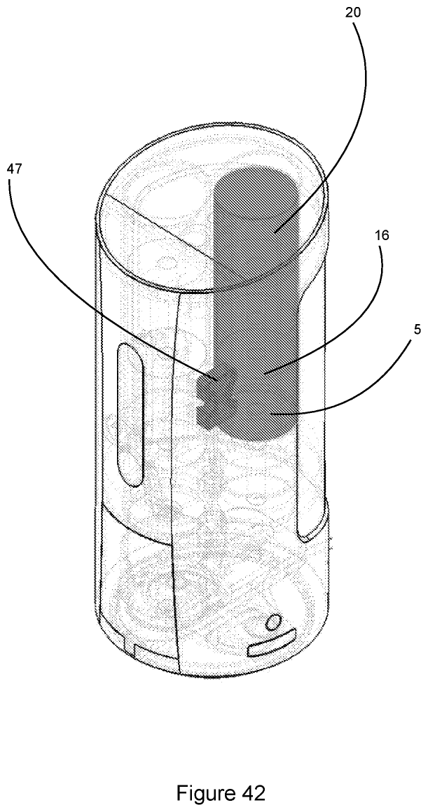

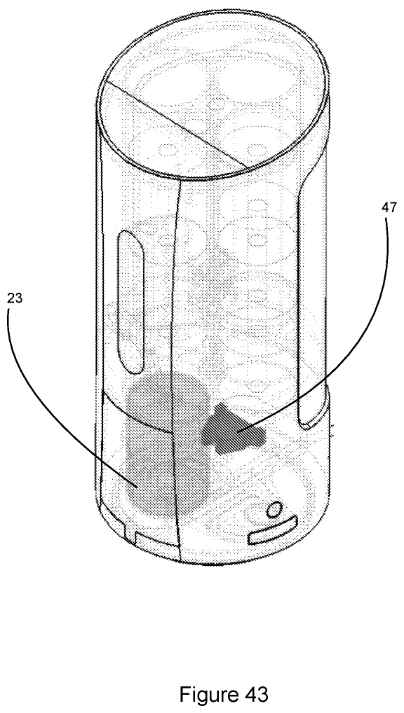

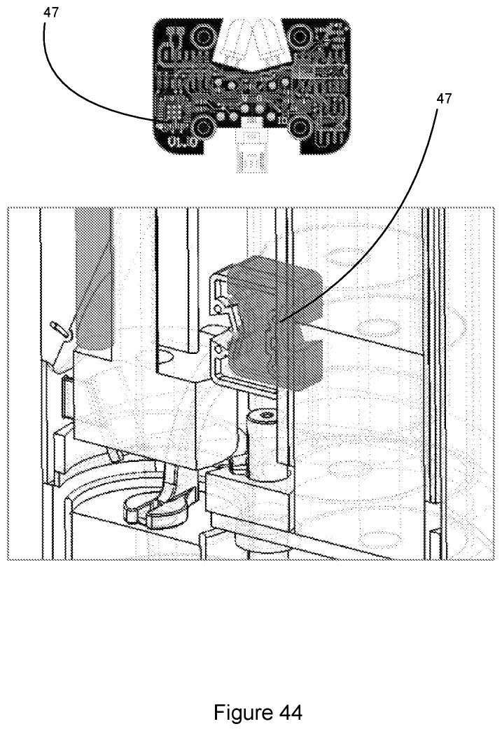

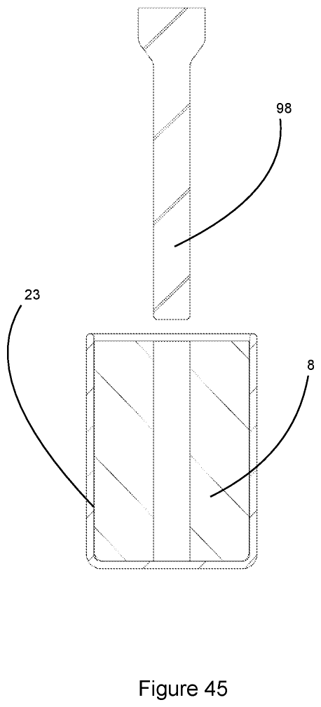

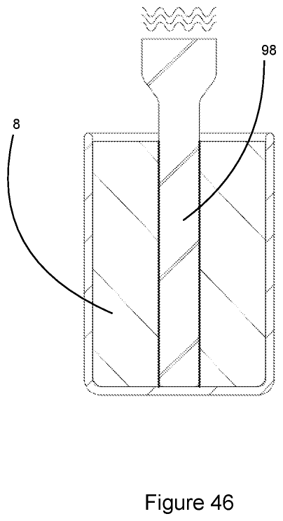

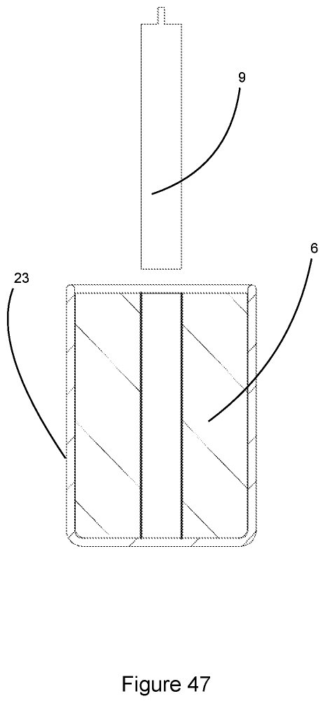

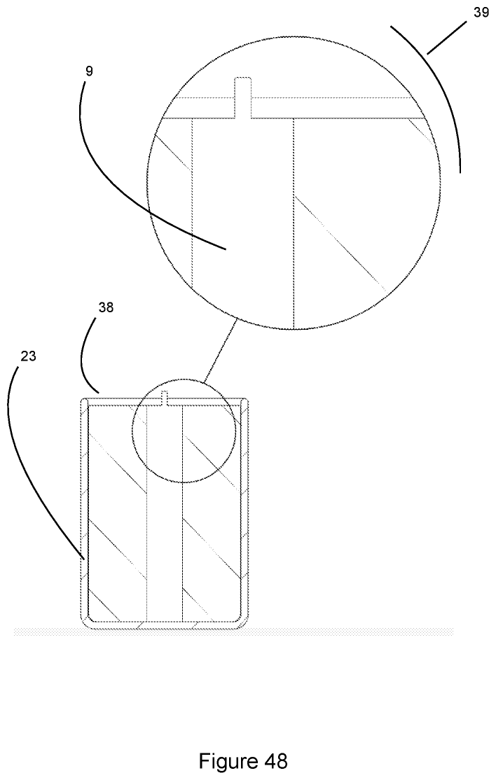

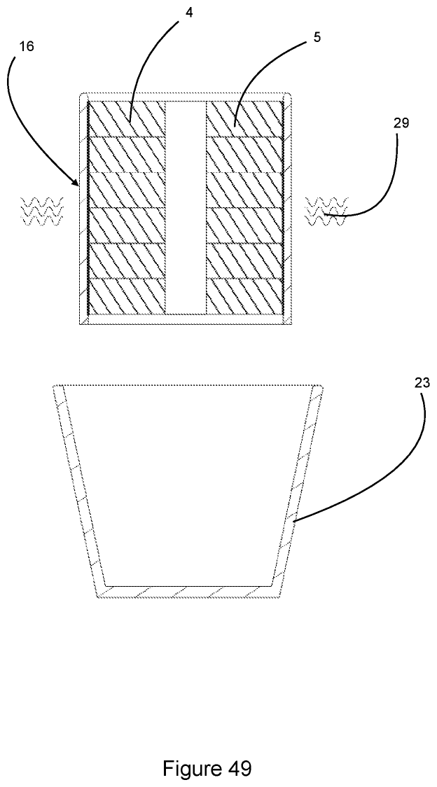

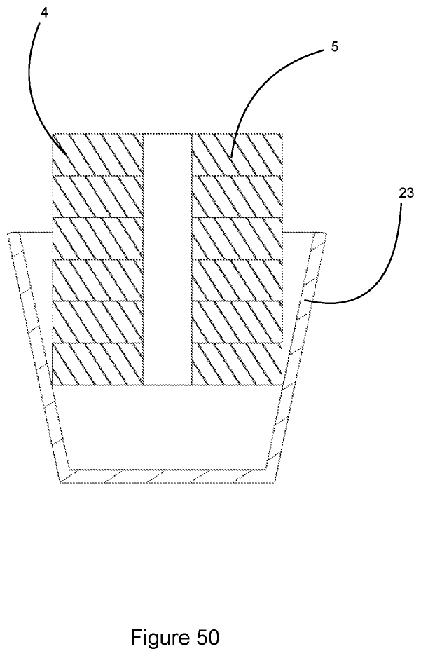

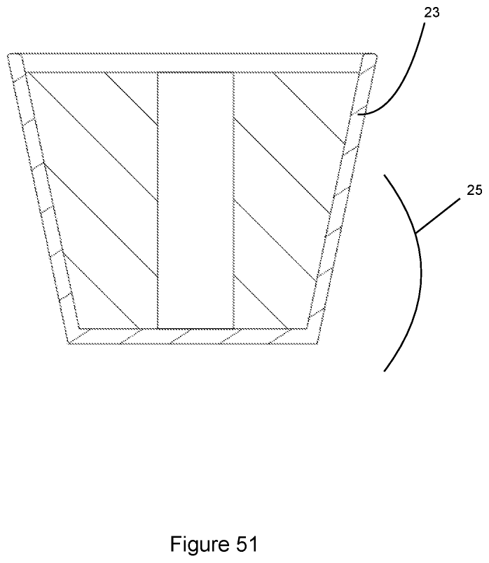

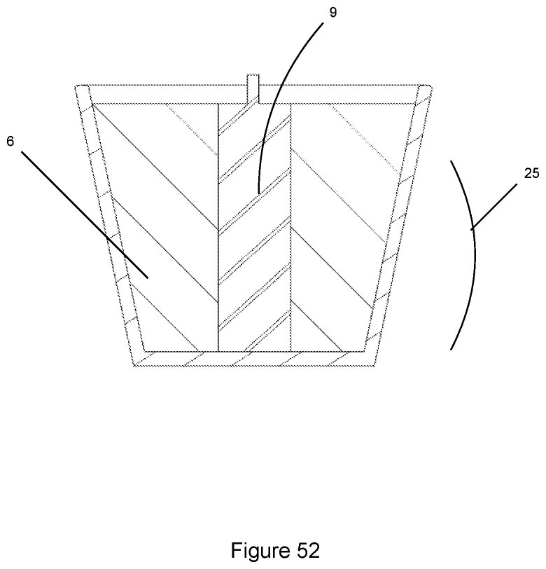

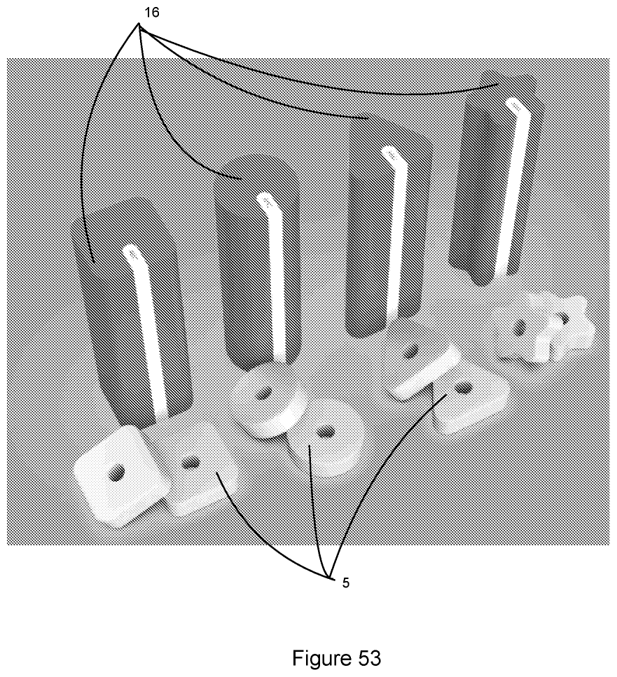

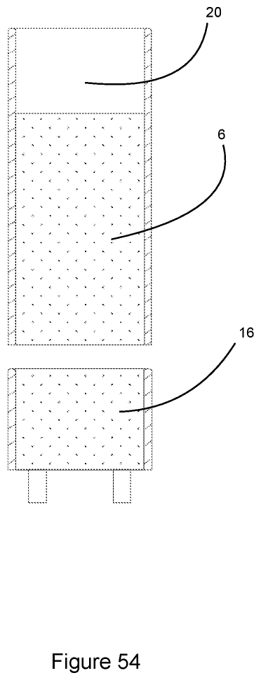

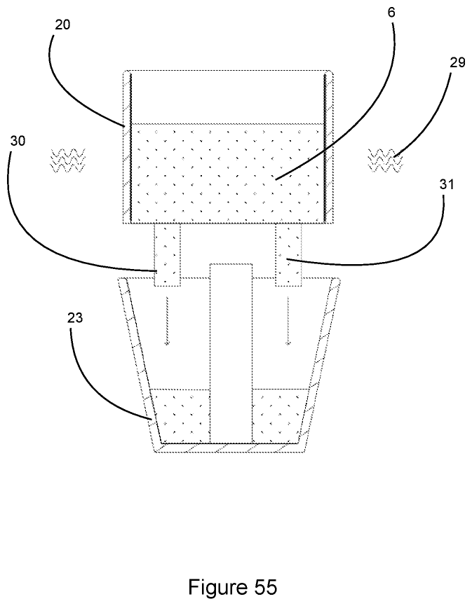

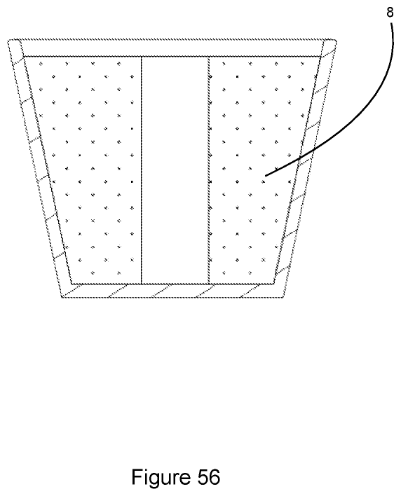

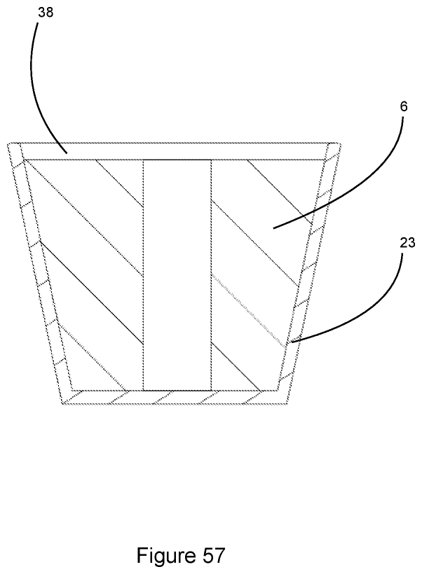

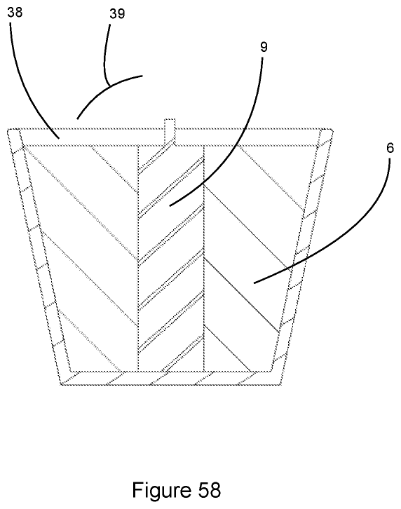

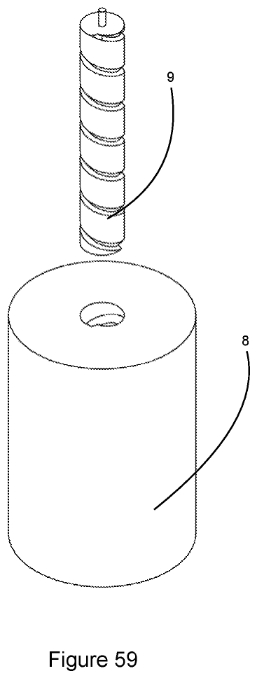

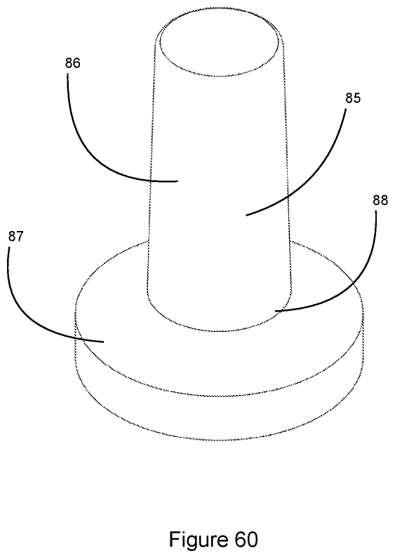

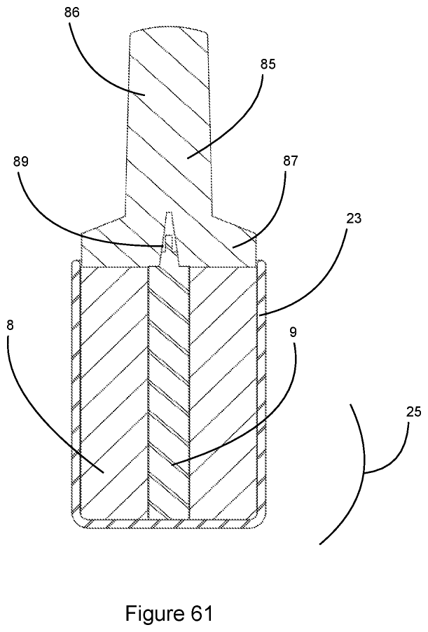

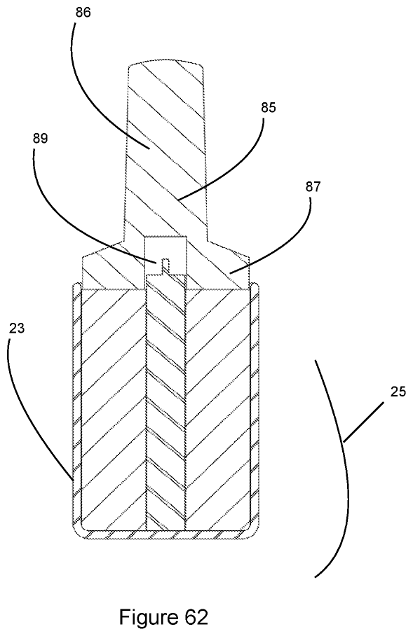

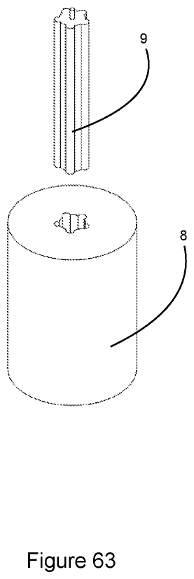

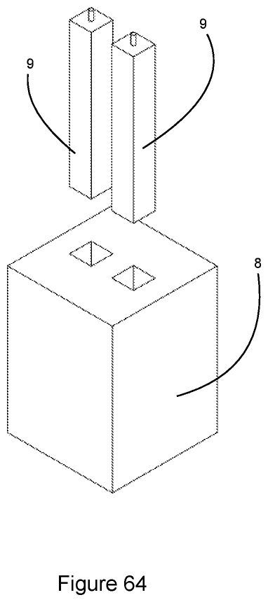

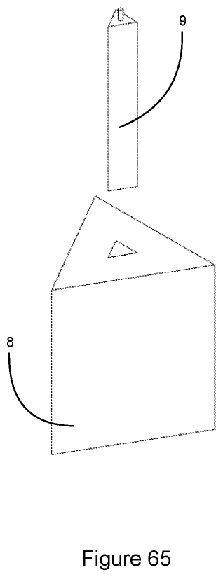

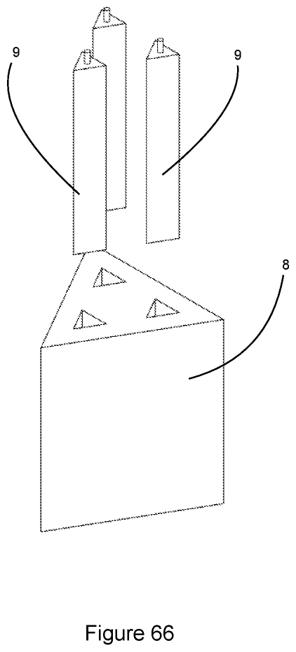

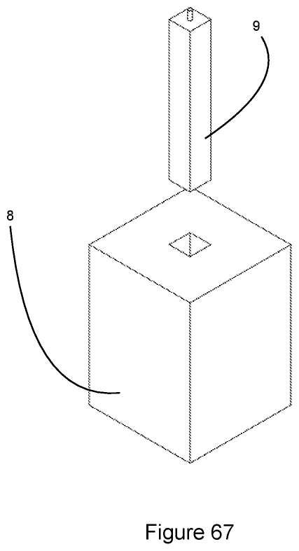

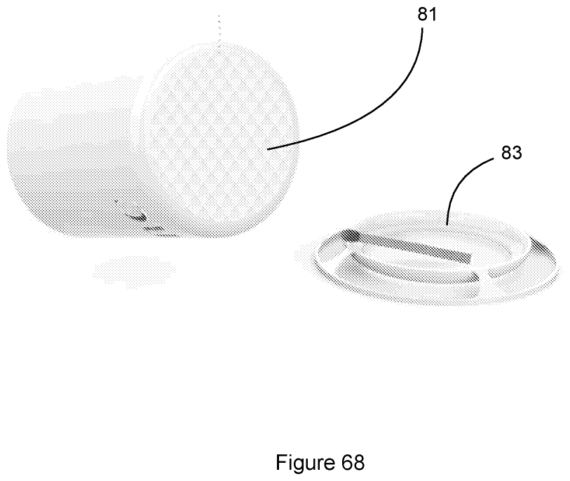

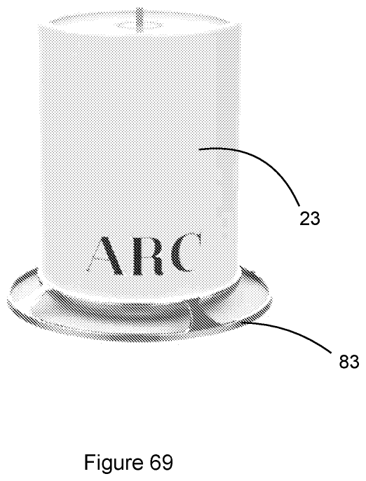

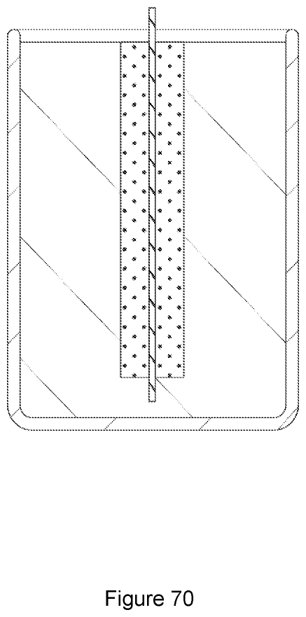

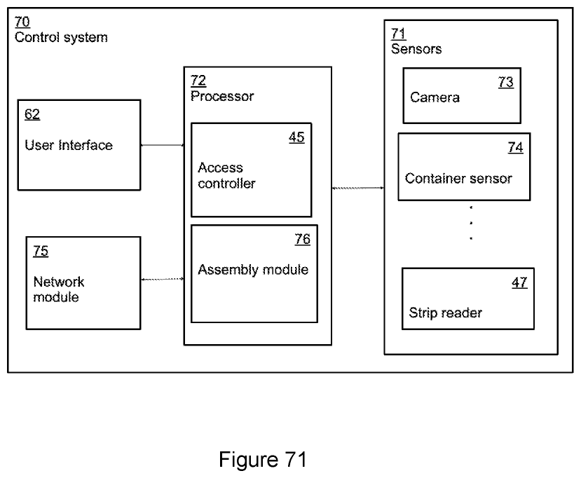

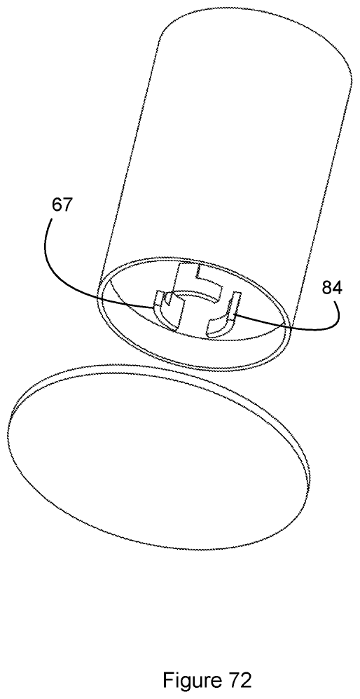

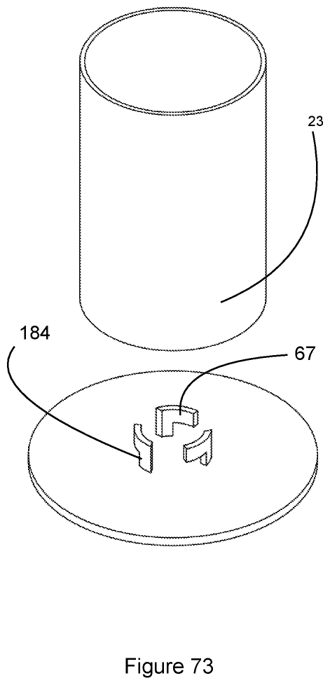

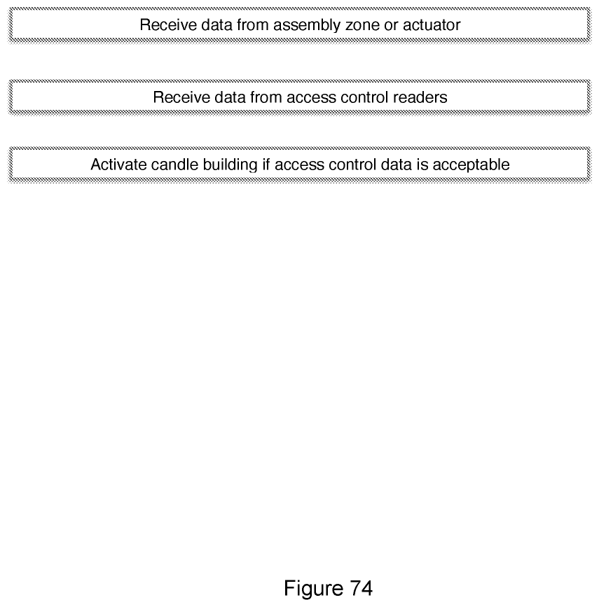

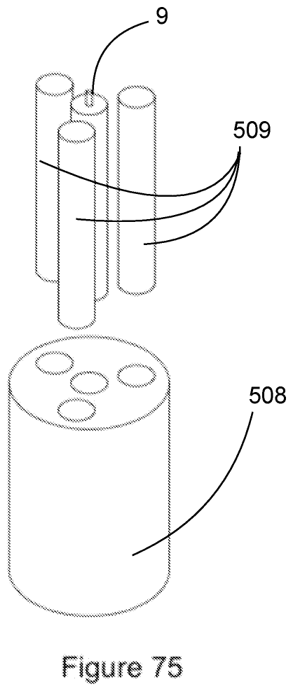

FIG. 10A is a side view of the apparatus shown in FIG. 9, but with one style of fuel element loading and closure shown;

FIG. 10B is a side view of the apparatus shown in FIG. 9, but with another style of fuel element loading, via a magazine shown;

FIG. 11A is a side view of the apparatus shown in FIG. 9, but with a still further style of magazine arrangement;

FIG. 11B shows a yet further magazine loading arrangement shown;

FIG. 12 is a front isometric view of the apparatus shown in FIGS. 9, 10 and 11;

FIG. 13 is a cutaway isometric view of the apparatus shown in FIG. 12;

FIG. 14 is a cutaway isometric view of a candle builder with wax cutter;

FIG. 15 shows the wax cutter in the candle builder of FIG. 14 half way through a cut in a wax fuel cylinder;

FIG. 16 shows the wax cutter at the end of its cut;

FIG. 17 shows a cutaway isometric view of a wax cartridge with a plurality of pucks disposed in a jacket;

FIG. 18 shows an isometric cutaway wax cartridge with a solid wax cylinder as fuel for a candle builder shown in FIGS. 14 to 16;

FIG. 19 shows an isometric cutaway fuel cartridge showing a liquid fuel such as an oil with an outlet at a base region of the cartridge;

FIG. 20 shows a side elevation section view of the liquid fuel cartridge shown in FIG. 19;

FIG. 21 shows an isometric view of a wax puck with fastening bosses;

FIG. 22 is an isometric view of another embodiment of puck which has gripping and locating formations on the top and bottom surfaces of the pucks;

FIG. 23 is an isometric view of another embodiment of puck with a further different set of locating formations;

FIG. 24 shows a kitchen or other working room where a candle building apparatus of an embodiment of the present technology shown built into a cabinet, the apparatus being operatively mounted on a slide for installation and maintenance;

FIG. 25 shows two different embodiments of candle assembly apparatus, one with a taper drawer for loading in a hollow fuel and another one shown without a taper drawer;

FIG. 26 is an isometric view of a wax puck shown with a square taper aperture;

FIG. 27 is an isometric view of a wax puck shown with a triangular taper aperture;

FIG. 28 is an isometric view of a taper;

FIG. 29 is an isometric view of the multi-scent taper;

FIG. 30 is an isometric view of a kidney-shaped taper;

FIG. 31 is an isometric view of a multi-scented kidney-shaped taper;

FIG. 32 is an isometric exploded view of a mobile candle builder with onboard power and charging dock;

FIG. 33 is an isometric exploded view of another embodiment of a mobile candle builder with onboard power and charging dock;

FIG. 34 is an isometric view of another embodiment of a candle building apparatus in the form of a vending machine;

FIG. 35 is an isometric view of two candle building vending machines;

FIG. 36 is an isometric detail view of a vending machine of FIG. 35 showing dispensing outlet;

FIG. 37 is an isometric view of a sample kit and scent sampler apparatus;

FIG. 38 is an isometric view of another arrangement of scent sampler apparatus;

FIG. 39 is a plan view of scent sample packets;

FIG. 40 is an isometric view of scent sample packet container;

FIG. 41 is an isometric cutaway view of a taper security reader;

FIG. 42 is an isometric cutaway view of a fuel cartridge security reader;

FIG. 43 is an isometric cutaway view of a container security reader;

FIG. 44 is a detail view of a security reader disposed in the candle building machine;

FIG. 45 is a front elevation section view of a heating element for facilitating coupling between the taper and the fuel;

FIG. 46 is a front elevation section view of the heating element driven into the fuel stack;

FIG. 47 is a front elevation section view of a taper being inserted into he fuel stack;

FIG. 48 is a detail view of a candle with taper and fuel stack and cover to retain any melted fuel in the container;

FIG. 49 is an exploded section view of a heating process wherein the fuel elements are heated so increase compliance with non-parallel walls of a container;

FIG. 50 is a section view of FIG. 49 wherein the fuel elements are being dropped/lowered/forced into compliance with the walls of the container;

FIG. 51 is a section view of FIGS. 49 and 50 wherein the fuel elements are pressed/lowered so that they conform to the walls of the container;

FIG. 52 is a section view of FIGS. 49, 50 and 51 wherein the container is closed with a retainer, and a scented taper is disposed in an aperture in the fuel element stack;

FIG. 53 are isometric views of fuel cartridges of different cross section;

FIG. 54 is a section view of a fuel cartridge with outlet drains for molten wax or powder or chips;

FIG. 55 is an exploded view of the outlets drains draining into a container;

FIG. 56 is a section view of the container of FIG. 55 with a retaining cap on top to retain any fluid fuel;

FIG. 57 is a section view of the container of FIG. 55 with solidified fuel;

FIG. 58 is a section view of a candle with a taper inserted;

FIG. 59 is an isometric view of a threaded taper which is configured to cooperate with a threaded bore in a wax fuel stack;

FIG. 60 is an isometric view of a wax tamper;

FIG. 61 is a side elevation section view of a wax tamper shown tamping a taper into a wax stack, which may or may not be formed from a plurality of wax blocks stacked one atop the other;

FIG. 62 is a side elevation section view of a wax tamper shown tamping a taper into a wax fuel block, which may or may not be constructed from a plurality of wax blocks;

FIG. 63 is an exploded view of a candle with a star shaped taper;

FIG. 64 is an exploded view of of a candle with two square-section tapers;

FIG. 65 is an exploded view of a triangular-prism candle with a single triangular section taper;

FIG. 66 is an exploded view of a candle with three triangular-section tanpers;

FIG. 67 is an exploded view of a candle with a single square section taper;

FIG. 68 is an isometric view of a stand for supporting a candle;

FIG. 69 shows a candle on the stand of FIG. 68;

FIG. 70 is a section view of a fuel block which has a blind bore for receiving liquid fuel or solid fuel;

FIG. 71 is a schematic view of a control system for controlling a candle assembly apparatus as herein described;

FIG. 72 is an isometric view of a container with interlocking formation;

FIG. 73 is an isometric view of an assembly zone interlocking formation;

FIG. 74 is a flowchart for an access control protocol in the candle assembly process implemented by the candle assembly apparatus described in this document; and

FIG. 75 is an isometric exploded view of a candle showing scented fuel plugs and a scented taper.

### DETAILED DESCRIPTION OF AN EXAMPLE EMBODIMENT

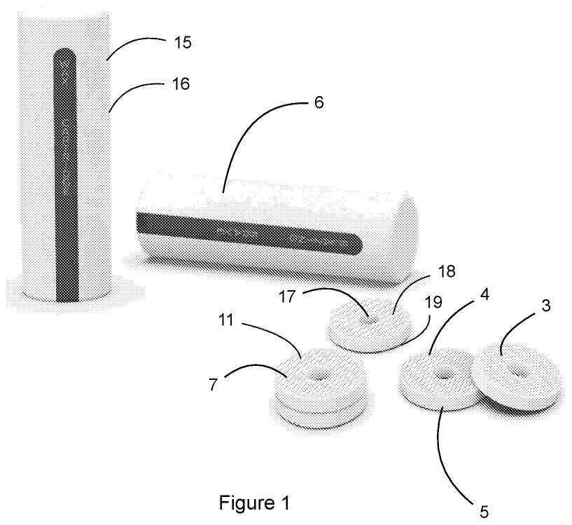

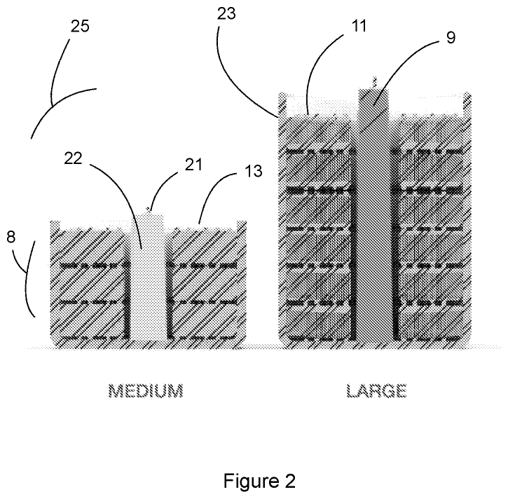

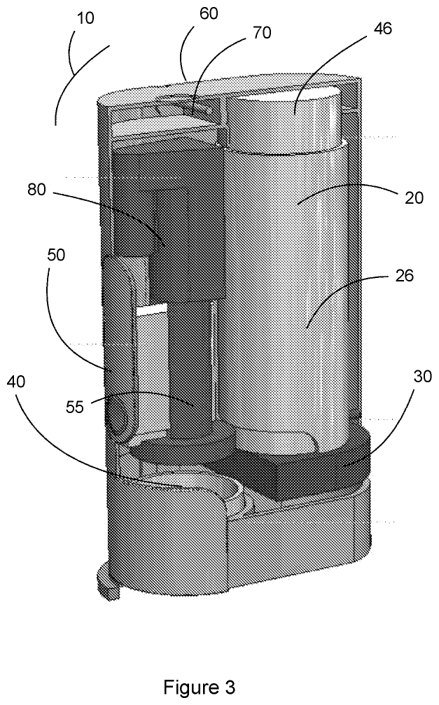

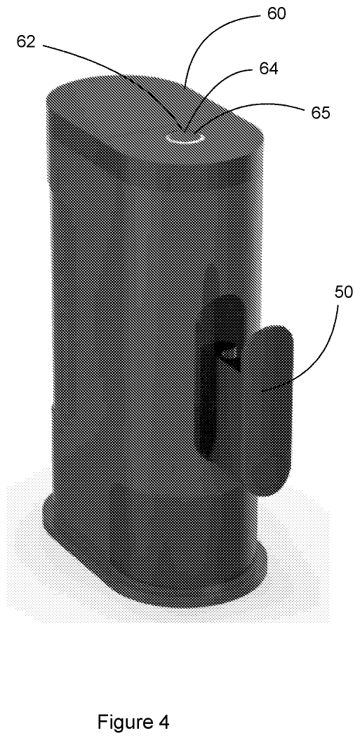

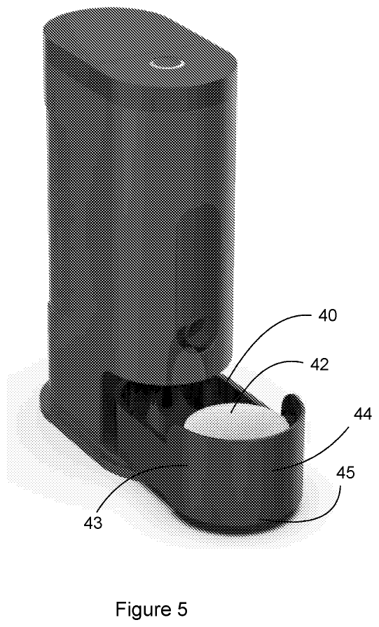

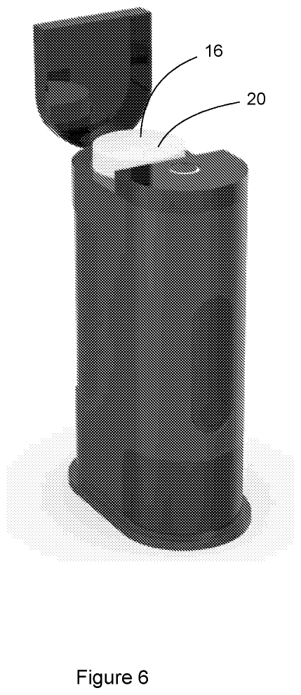

Referring to FIGS. 1 and 2 there is shown fuel 6 for feeding a candle building or candle assembly apparatus 10. The fuel is generally indicated at 5. The candle building or candle assembly apparatus itself is shown, in a first embodiment at FIGS. 3 to 6 and, in a second embodiment at 7 to 11. Both apparatus are generally indicated with the numerals (first embodiment) 10 and (second embodiment) 110.

When discussing the two embodiments of candle assembly apparatus 10 and 110, the first embodiment will have numbers between 10 and 100, and the second embodiment will be indicated with numerals between 110 and 200. Like parts of each embodiment will be indicated by like numerals across the embodiments, so, for example, the reservoir 20 in the first embodiment will be indicated by reservoir 120 in the second embodiment.

So, broadly, the candle assembly apparatus 10, 110, 210, includes a housing 60, a reservoir 20 in the housing 60 for holding fuel 6 in the form of one or more fuel elements 5, and a dispenser 30 for feeding one or more of the fuel elements 5 from the reservoir 20 to an assembly zone 40 to form a fuel stack 8. A control system 70 that includes a processor 72 is disposed in the housing 60 to control aspects of the assembly process described below.

The apparatus 10, 110 further includes a loader 50 for loading a taper 9 into the fuel stack 8 in the assembly zone 40. An alternative embodiment shown does not include a loader 50. When there is no wax cutter, the dispenser 30 is configured to work with a stack of wax pucks 4, which may have integral tapers 9, which can be merely dropped or dispensed from the reservoir in operation and stacked in the assembly/loading zone in operation, or the builder may include a wax cutter 90 to form one or more smaller fuel elements 5 or pucks 4 for the dispenser 30 to drop into the assembly zone.

### Fuel Elements and Cartridges

Fuel is in the form of fuel elements 5 and in the form shown, each fuel element 5 includes one or more debossed and/or embossed surface portions 7 configured to cooperate with other like fuel elements 5 when one is stacked atop another (cf FIG. 2). The fuel elements 5 in the form shown are pucks 4, which are a substantially homogenous solid block 3 as shown.

There may be pucks 4 provided, which include a skin 2, which may be a band or wrap element 1 for at least partially, or fully surrounding fuel element 5. The fuel blocks 3 are solid wax, and have a through hole 17 from the top surface 18 to the bottom surface 19 to receive a taper 9, which is a scented wax jacket 22 around a wick 21. The wax in the puck 4 may be beeswax, vegetable wax, mineral wax, animal wax, soy wax, paraffin wax or other suitable wax. The wax in the fuel puck 4 is intended to have no scent, and it is intended to be slightly less expensive than a scented wax unit 9. This is one of the advantages of the technology, where the candle overall is less expensive for end users than using the entire candle block of scented wax. In any event, the scent of a fully scented candle can also become overpowering, so this embodiment of the technology balances the scent with long term fuel burning, light and ambience.

Where the fuel in the puck 4 is liquid fuel or oil, which is contemplated as a fuel for the assembly apparatus, the skin would form a complete skin and fully surround the fuel, but a puck 4 would still be formed. There would even be as part of the puck 4, the through hole 17, so as to form a donut or toroid, or cylindrical disc with a through hole 17 (in some embodiments such as those with a circular cross section), as discussed below.

It is the surface of the puck 4 which is embossed to form locating or fastening surface formations 11 integral with the puck body. The embossed locating or fastening surface formations 11 may be knurled, stamped or moulded formations extending above the surface or the skin. They are intended to be bosses 12, being small stacks 13 about 1 mm across and about 1 mm or 2 mm high and intended to be configured to crush or melt into one another to fuse or bond different adjacent pucks 4 together. There may be any kind of arrangement of stacks, including those across the top and bottom surfaces nearly to the edges, or they may be in a kind of mating arrangement, where half the top surface may be embossed, while the other half may be free, so as to facilitate fastening to an adjacent puck 4. The bosses 12 may be spaced to allow an inter-fit location between surfaces of adjacent pucks 4, where there is not really much crushing, but merely just an accommodation where one boss on one surface fits between two bosses on the corresponding surface of the other puck 4.

The skin or the wax may be provided with recesses and/or bosses 12, and they may be moulded on or pressed on into the skin or wax surface. FIG. 21 shows small round flat-topped bosses in rows.

It can be seen that the bosses 12 can take the form of spaced-apart arcuate ribs (FIG. 22), or, as shown in FIG. 23, spaced-apart radial ribs. Other forms are also possible, for example, where the bosses are conical.

The skin 14 may be a packaging layer 15 for a wax puck, or indeed the packaging layer may be a separate layer on the outside of the other skin. The packaging layer 15 is a cartridge for containing one or more of the fuel elements 5.

The packaging layer 15 includes a sleeve 16 which form a cartridge 16A for receiving the one or more fuel elements 5. In some embodiments the sleeve 16 may receive a plurality of pucks 4, but there will be embodiments available, it is contemplated, where there is just one long pillar disposed inside the sleeve, and a dispenser includes a cutter (not shown) to cut off a selected length of the fuel pillar. In the embodiment shown, it is to be understood that there will be a plurality of fuel elements 5 disposed in the cartridge sleeve 16, perhaps separated if necessary by a liner to inhibit welding together in the sleeve 16, but the dispenser, as will be explained below, will select one puck 4 at a time, and drop each one in the assembly zone 40 for assembly with a taper 9 and combining with the other pucks 4 by pressure.

In one embodiment the packaging layer includes a cardboard tube element for protecting the fuel element from damage and from adjacent fuel elements during transportation or during use or storage.

The skin 14 may be scented with a scent, but it is to be understood that the main scent unit is the taper 9. The taper 9 is intended to be sold in stacks, which may be cylindrical to fit in an (optionally) cylindrical through hole through the pucks 4. It is contemplated that the tapers 9 may be semi-cylindrical in section (to obtain a scent mix by placing two together in the through hole 17.

The skin may be about 0.1 mm thick or about 0.2, 0.3, 0.4, 0.5, 0.6, 0.7, 0.8, 0.9 or 1.0 mm thick.

Many puck 4 shapes are contemplated to work, and each kind has different advantages: cylindrical pillars are easy to load, easy to handle, to hold in the hand, and make an attractive pillar candle.

But the puck 4 may be a square prism to facilitate ready formation of a square-sided pillar candle, which can be attractive. This is shown in FIGS. 53, 64 and 67.

The fuel element 5 may be in the form of a square-section pillar (FIG. 53), or a cylindrical pillar (FIG. 53), or a triangular-section pillar (FIGS. 53, 65 and 66), or a star-section pillar (FIG. 53).

For that matter, the through holes 17 in the fuel element 5 may be square, splined or star shaped (FIG. 63), triangular (FIGS. 65, 66) or other useful and attractive feature. The through hole 17 does not have to be the same shape as the shape of the fuel element 5, as shown in FIG. 63 where the taper hole 17 and taper 9 is star shaped in section while the fuel element 5 is cylindrical. The greater the contact area the greater the heat transfer from taper 9 to fuel stack 8.

Each fuel element is about 10 mm high and about 30 mm across.

Other useful dimensions of the fuel element 5 are contemplated for various reasons, and advantages, and they may be about 5 mm, 7 mm, 12 mm, 15 mm, 18 mm, 20 mm, 25 mm, 30 mm, 35 mm, 40 mm, 50 mm, 60 mm, 75 mm, 80 mm, 90 mm, 100 mm, 125 mm, or 150 mm high. For various reasons, the fuel elements may also be about 20 mm, 25 mm, 35 mm, 40 mm, 45 mm, 50 mm, 55 mm, 60 mm, 75 mm, 80 mm, 90 mm, or 100 mm across.

As shown in FIGS. 64 and 66, there may be more than one through hole 17 through the pucks 4. Each one may be about 5 mm across and may be slightly tapered from bottom to top to assist loading into the through hole 17.

The hole 17 for the taper 9 may be square in section as shown in FIGS. 53 and 26, or they may be triangular in section as shown in FIGS. 27 and 53 or they may be circular as shown in 21 to 23, or they may be kidney-shaped to take a kidney shaped taper as shown in FIGS. 30 and 31. These shapes may have advantages in locking the pucks 4 together, and where there is a fine vertex, there is likely to be slightly higher temperature and heat welding. The shapes may also facilitate grip when handling, such as for example the kidney-shape facilitates a finger hold to provide a secure fit in the fingers when handing and inserting into the builder.

FIG. 59 shows a taper 9 that includes a thread formed on its outer surface. The Figure also shows a cooperating thread on the through hole 17 of the fuel element 5.

The taper 9 wax scent includes essential oil to provide the scent.

The taper 9 may be infused in the wax with a medicament such as antiviral, or antibacterial medicament.

Taper 9 shown in FIG. 30 is a kidney shaped taper. The kidney lobes 9d and 9e lock the taper 9 into cooperating lobes (not shown) for more security and more friction when interlocking. This increased surface area increases heat transfer to the fuel in the fuel stack 8.

The taper 9 is shown in FIG. 31 as a multi-scent taper, where the top portion 9a is one scent, a mid portion 9b is a different scent, and the base portion 9c is a different scent. For example, the top portion may be a scent such as peppermint for energy, while the middle scent may be infused with lavender to calm the nerves, and then the base is chamomile to aid in sleep. As the candle burns down, the user is sent slowly into an ever-more relaxed state.

It can be seen in FIG. 75 a candle 525 that includes three scented fuel plugs 509 which are disposed in a fuel stack 508, radially outwardly of a central taper 9, which may or may not be scented. The reason for the three scented fuel plugs 509 is so that the candle 525 may provide a stronger scent when in use. In fact it is contemplated that there may not even be a central taper 9 but a solid fuel stack 508 which has an integral wick, but the scented fuel plugs 509 provide the scent, but no wick.

### The Candle

So, the candle 25 produced by the assembly apparatus 10, 110, 210, is shown in

FIG. 2 and includes, one or more fuel elements 5 stacked one atop another, and a scented taper 9 disposed in the one or more through holes 17. The container 23 may be provided to neatly present the resulting pillar candle 25, and to provide it with support and wax retention during use, or it may stand alone.

A medium candle and a large candle are shown in FIG. 2, and this shows the flexibility of the apparatus 10, 110. The apparatus in use will count off the desired number of fuel elements 5, which in use are extracted from the cartridge sleeve 16, stack them into the container, or merely one atop another, and then drop or drive the scented taper 9 into the through hole 17.

If the fuel is liquid, it can be a good idea to include a closure on the container.

Alternatively, the candle 25 includes a single block fuel element 5 cut from a fuel block in a cartridge 16A. The process and the apparatus for cutting the fuel element 5 from the fuel block in a cartridge 16A is described below and shown in FIGS. 14 to 16. The scented taper 9 is then dropped, screwed, pressed or driven into the through hole 17 to provide the one or more candles shown in FIGS. 63 to 67.

### A Candle Assembly Apparatus Reservoir

The housing 60 is provided to protect and support the components described below, the housing 60 including a user interface 62 for actuating the candle building process. The housing 60 includes an access means 61 for loading fuel into the reservoir 20. The access means 61 may be a lid 61 or a port (not shown). The port may have an automatic lid which swings out of the way when the solid fuel block 5 or the cartridge 16 is inserted. The access means 61 is intended to provide access for solid fuel blocks. The lid 61 could be hinged or sliding.

The reservoir 20 is disposed in the housing 60 and is configured to receive and temporarily hold about ten, a dozen, fifteen, twenty, twenty five, thirty, thirty five, or up to about fifty fuel elements 5. The fuel elements 5 are in a stacked disposition inside a cartridge 16, which can be loaded straight into a tube 26 of the reservoir 20. The reservoir includes at least one hollow tube 26 of a cross sectional dimension and shape which cooperates with that of the one or more fuel element cartridges 16. One form of cartridge 16 contains a solid fuel pillar and the dispenser 30 dispenses fuel elements 5 by cutting one or more from the solid fuel pillar as described below.

In the apparatus shown in FIGS. 3 to 6, the reservoir only has one hollow tube 26.

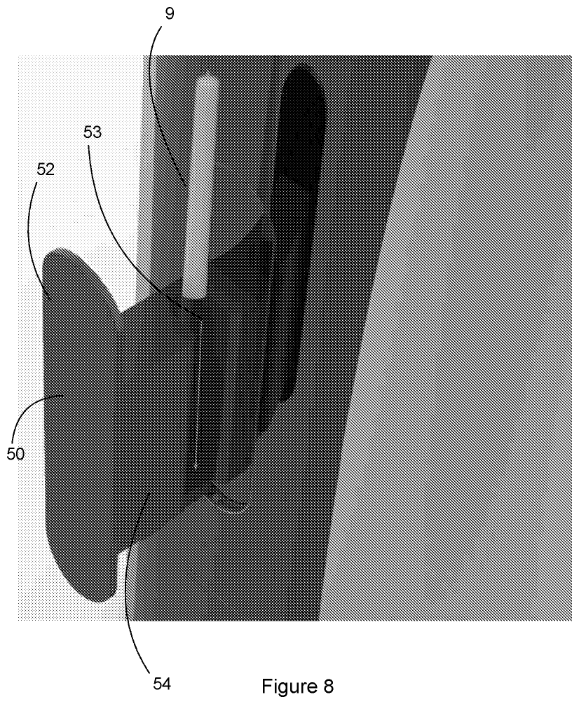

In the apparatus shown in FIGS. 7 to 16, the reservoir 20 includes three hollow tubes 26, disposed side by side in a magazine arrangement. A magazine frame 27 is provided which is configured to receive three fuel cartridges 16 (or, as herein discussed, monolithic fuel pillars or stacks of fuel elements 5, which may be provided without any kind of covering).

The cartridge outer jacket 16A may act as a loader for the wax blocks. The wax block or pucks may be dispensed therefrom into the magazine. This makes cutting fuel elements or pucks 4 from the block of fuel 5, and dispensing, easier.

The fuel magazine fame 27 is configured to operatively mount into the reservoir 20 for ready loading. The fuel magazine frame 27 is shown to slide from above, swing from one side, or slide in from the side as shown in FIGS. 10 and 11.

The reservoir 20 includes an inlet 28 at a top end and an outlet 29 at a base end for fuel 5 flow into and out; the outlet leading to an inlet of the dispenser 30 for transferring one or more fuel elements 5 thereto.

The reservoir 20 includes a heating unit 29 which is in the form of a heating jacket and is shown in FIG. 49. The heating jacket 29 can melt the fuel in the reservoir 20 so that the wax flows from dispensing outlets, or it can merely warm the wax so that it can be forced, under pressure from the press 80, to conform to the walls of a container.

The heating unit 29 may facilitate the use of wax flakes or granules, which can be melted or warmed to form a more dense fuel block.

The fuel used in the reservoir may be flakes or granules or solid blocks, since they can be pressed with the press 80. The press 80 and/or the heat can still facilitate a the convenience discussed herein, being a fairly rapid candle formation process.

### Dispenser

The dispenser 30 includes an inlet closure 32 for selectively inhibiting access of fuel elements 5 from the reservoir 20. The dispenser 30 also includes an outlet 33 for transporting the fuel elements 5 from the reservoir 20 to the assembly zone 40.

The dispenser 30 includes a selector 34 for selecting a particular one or more fuel elements from selected portions of the tube 26 or magazine 27. The selector 34 is a rotating transporter 35 which includes one or more recesses 36, cooperating in cross section with the fuel elements 5 for receiving fuel elements 5 for loading into the assembly zone 40. The selector 34 in an embodiment not shown, is a drive for rotating the magazine 27 to align the reservoir outlet 29 with the dispenser inlet for transport to the assembly zone 40.

The dispenser 30, in one embodiment (FIGS. 14 to 16) includes the cutter 90 which includes a cutting arm or cutting carriage 91 and a hub 92, and a cutting element 93 in the form of a cutting wire 94 which extends between the hub 92 and the cutting arm or carriage 91. The hub 92 which includes an adjuster 95 for adjusting the height of the cutting wire 93. The adjuster 95 includes a hub carriage 96 and an arm carriage (not shown) which can help to adjust the height of the cutting wire 94 by elevating or lower the wire 94 depending on instructions from the computer controller.

### Loader

The loader 50 includes a loader 52 for loading the taper 9 into the fuel stack 8. The loader 52 includes a holder 53 for holding the taper 9 so it is kept in a stable position on the loader 52 while the loader is in motion. The holder may be a clamp or at least a pair of resilient jaws for holding the taper 9.

The loader 52 includes a drawer 54 which is disposed in a wall of the housing 60, which receives the taper 9 from the user, and transporting the taper 9 to the assembly zone 40. The loader 50 includes a drive 55 for driving the taper 9 into the fuel stack 8; or, the loader 50 includes a clamp and a release to drop the taper 9 into the stack 8.

The drive 55 includes a press 80 for pressing the taper 9 into the fuel stack 8. The press 80 includes a press plate 82 for pressing the stack together and for pressing the taper 9 into the stack.

### Assembly Zone

The assembly zone 40 includes a loading zone 42 at an entrance thereof, for receiving a candle container 23. The loading zone 42 includes a door 43 for controlling access to the assembly zone 40. The loading zone 40 includes a drawer 44 to assist in transporting the container 23 to the assembly zone 40. The loading zone 42 includes an access controller 45 described below for inhibiting access to unauthorised containers.

### Sampling Module

Shown in FIGS. 37 and 38, the housing 60, 360, includes a scent sampling module 91 for dispensing sample scents. The sampling module 91 includes a sample receiving dock 92 for receiving a sample fuel element 93, and a heating unit 129 disposed in the dock for heating the sample fuel element 93. The sample receiving dock 92 is disposed on a landing body 94, on a distal end.

The landing body 94 is an extendable drawer 96, extendable from the housing 60, by swinging or sliding from the housing 60. A button 97 is configured to unlock and extend the drawer 96. In one form, the sampling module is disposed under a closure 32 for the housing 60.

### Sampler Kits

As shown in FIGS. 37, 39 and 40 there are scent sample kits 78 including a tray 79 of scented wax buttons 93 disposed thereon. The scent sample kit 78 includes a packet of wax buttons 77 for mounting in the dock 92.

A wallet 76 of scent samples is shown in FIG. 40, the wallet 76 including a housing 74 for receiving a plurality of scent sample packets 77, and an access opening 73 for removing one scent sample packet 77 from the wallet 76.

### User Interface and Control

The housing 60 includes a user interface 62 for actuating the candle building process. The user interface 62 includes an actuator 64 which causes the building process to commence. The actuator is a button 65 for simplicity of use.

Referring to FIG. 71, there is provided a control system 70 within the housing 60 for controlling the operation of the machine 10, for example controlling the assembly/build process. The control system includes a processor 72 configured for controlling the loader 50, the dispenser 40, the drive and press 80. The processor is configured to include an access controller 45 and an assembly module 45. The control system 70 further includes various sensors, for example an optical sensor such as camera 73 for assessing the size of a container, container sensor 74 for sensing the presence of a container in the assembly zone 40, and a reader 47 used to determine the presence of an identifier located with, on, or within a fuel element 5 and/or fuel cartridge 16. The processor 72 is configured to execute an assembly module 76 for making decisions on assembly steps in response to user inputs received from the user interface 62 and/or in response to inputs received from one or more of the sensors 71.

The processor 72 may be any suitable microprocessor, for example an ESP8266 with Wi-Fi capability, or an ESP32 with Wi-Fi and Bluetooth capability. In some embodiments a single processor may be used. In other embodiments one or more processors may be used to implement various functions of the machine 10 as described herein

The onboard processor 72 is configured to instruct the building of a candle upon receipt of data relating to the presence of an authorised container, or in response to a press of the actuator 64. Candles of a selected height may be assembled, under the control of the processor 72, depending on the length or number of presses of the button 65. In one embodiment, the onboard processor 72 is configured to implement the assembly of a candle of a low height (two fuel elements) if the button 65 is pressed once, and of a medium height (three fuel elements) if the button 65 is pressed two times, and of a tall height (four fuel elements) if the button 65 is pressed three times. The control system 70 includes a wireless module 75 for communicating with a mobile device for configuration and remote control.

Alternatively the processor 72 may instruct the cutting of a fuel block 5 from the fuel 6 in the reservoir 20 by actuating the cutter 90 and dispensing the fuel block 5 into the container in the assembly zone 40.

On the actuator button 65 there is disposed a biosensor which identifies the fingerprint of the user as authorised to operate the candle builder.

### Access Controller

The access controller 45 its in communication with a reader 47 and an interlock module 48 in the processor so that only containers and fuel which are of a selected geometry or fitted with a security coating or strip or tag are allowed through into the loading/assembly zone 40. FIGS. 72 and 73 show an example geometric feature which is disposed at the base of a container. The container interlocks with the lock tabs in the loading/assembly zone 40 and a camera or sensor disposed in the loading/assembly zone 40 and shown in schematic view in FIG. 71 identifies that the container is disposed in an interlocked position. Then the access controller 45 either moves to receive data from the reader (disclosed below) or provides authority for the candle building process to begin.

The access controller 45 also inhibits operation of any part of the candle assembly apparatus 10 until a reader 47 reads an authorised message on a security coating or strip or tag, which may be disposed on the container or the wax fuel 5 or the taper 9. There is provided a magazine access controller 46 which includes similar interlock features as those of the loading zone access controller 45. The magazine access controller 46 includes a reader 47 to read a security coating or tag or strip on the fuel cartridge or fuel pillar. The access controller and/or magazine access controller includes an optical reader to read a barcode on the magazine, fuel cartridge or container. The barcode is stamped into the fuel. If the reader 47 reads the right code on the security strip then the access controller allows the candle assembly to begin. The reader 47 adjacent the taper loader drawer also provides access control. These access control readers are shown in FIGS. 41, 42, 43 and 44.

An alternative access controller is arranged such that there is a biosensor for detection of a selected gene or constituent part of the wax. Only authorised types of wax are contemplated to be able to be used in the candle builder 10, 110 and the authorised type of wax is identified by the biosensor. The biosensor is a gene sensor which identifies a selected wax or scent by the presence of a gene or other watermark. The biosensor is operatively connected to an interlock and the interlock will shut down the operation of the candle builder if the gene is not detected in the wax or cartridge or candle container in the assembly zone.

### Tracking Fuel Elements and Cartridges

In some embodiments, the machine 10 includes one or more sensors 71 adapted to sense an identifier associated with a fuel element 5 and/or a fuel cartridge 16. The identifier may be associated with one or more identification particulars such as the type of fuel, the origin of the fuel, a vendor or manufacturer of the fuel, etc. The processor 72 is configured to receive the identifier data from the sensor 71, and to cause the network module 75 to communicate the identifier data to an external and/or remote computing system, for example a user device (such as a smart phone or laptop), a server, or a computer, etc.

The processor 72 may be any suitable microprocessor, for example an ESP8266 with Wi-Fi capability, or an ESP32 with Wi-Fi and Bluetooth capability. In such embodiments, the network module 75 would then include the onboard networking capability of the microprocessor.

In some embodiments the identifier may include an optical identifier such as a QR code; in these embodiments the sensor 71 includes an optical sensor such as a camera configured to input the QR code and provide the QR code data to the processor 72 for extracting the identifier data.

In some embodiments the identifier may include a radio frequency identifier (RFID) in the form of a passive or active RFID tag. The sensor 71 in such embodiments includes an RFID antenna adapted to query the RFID tag and to communicate the RFID tag identifier data to the processor 72.

It will be appreciated that various forms of identifiers can be used (tags, labels, etc.) that are adapted to be sensed by associated sensing mechanisms, for example optical codes such as barcodes, proximity cards using near-field communication (NFC), location tracking technologies such as GPS, nanotechnologies or nano-barcodes, etc.

In some embodiments the control system 70 functions as a reader, whereby the sensors 71 sense or detect an identifier, and the processor is configured to process the sensed data in order to read the data associated with the identifier. In other embodiments, the machine 70 may include a separate reader comprising a reading sensor and an associated reader processor.

In some embodiments the machine 10 includes a machine identifier. In these embodiments, the processor 72 may be configured to associate the element identifier and the machine identifier, and to cause the network module 75 to transmit the associated identifiers.

In some embodiments the sensor 71 is adapted to sense the presence of a fuel element 5 in the dispenser 30, and the sensor 71 communicates each instance of an element 5 to the processor 72, and the processor 72 is configured to count a number of elements 5 used with the machine 10. In some embodiments the sensor 71 is adapted to sense the presence of an element 5 or a cartridge 16 in the reservoir 20 and to communicate each instance of an element 5 or a cartridge 16 being received (or replaced) to the processor, and the processor 72 is configured to count the number of elements and/or cartridges used with the machine 10.

### Power Supply

One embodiment of the assembly apparatus, shown in FIGS. 7, 10A and 10B, is powered by mains power. As is typical with bench top appliances for the home, the assembly apparatus may operate on 240 v/110 v at 50/60 Hz, and utilises a plug for connecting to a GPO (general power outlet).

Another embodiment, shown in FIGS. 32 and 33, is powered by an onboard power supply, being a battery or capacitor or other power or heat storage device such a solid graphite block, molten salt, or water. The battery or onboard heat or energy storage is charged by a charging dock 77. While the batteries could be in the form of disposable batteries, in the embodiment shown, the housing 60 is configured to dock in the dock, for charging. The battery on board may release power to form and build a candle when travelling in remote places, or in the bedroom or bathroom or rumpus or shed. The whole candle building apparatus is then portable.

### In Operation

In operation the processor 72 wakes up when it receives data from a sensor 71, for example the camera 73 or container sensor 74, if a container is detected in the assembly zone 40 or when the processor 72 receives data from the user interface 62, eg from button 65 to wake up and start the assembly process. The sensor or camera checks whether the container is locked into the loading drawer by checking clearance between the container and the base of the drawer. The camera or sensor may assess the size of the container and send that data to the processor 72. If the container is assessed to be below a small threshold, then the processor 72 will instruct the dispenser 30 to cut or dispense a small size or number of fuel elements 5. If the container is assessed to be medium sized, then the processor 72 will cut or dispense a medium size or number of fuel elements 5. And so on for large size containers.

The processor 72 receives data from sensors in the loader 50 that the loader drawer 52 is open. The user inserts the taper 9 into the loader 50. The access control reader 47 adjacent the drawer 52 reads for the security strip on the taper 9 and if it is present, then the access control module allows the loader 50 to proceed with loading the taper into the fuel stack 8 described below.

The processor 72 then actuates the dispenser to cut, using the cutter 90, a fuel element 5 from the fuel 6, of the right size for the container. If the cartridge 16 has a plurality of fuel pucks 4 stacked therein, then the processor 72 causes the turntable to rotate to fill the container with the right number of wax pucks 4 to form a stack 8 of the right size for the container.

The wax puck dispenser 30 dispenses pucks in a stack in the container.

The processor 72 may actuate the heating probe 98 to warm the inside of the bore in the stack 8. There may also be provided a heating jacket around the cartridge 16 to warm the wax up to a temperature where the wax may slump or be formable under pressure. This is suitable for a container 23 which has angled or curved walls. This arrangement is shown in FIGS. 49, 50, 51 and 52, where the wax can be slumped with a little heat to allow the press 80 to form it against the walls of a non-straight sided container 23.

The processor 72 then causes the press 80 to drive the taper from the loader into the bore of the stack 8.

The other embodiments of the apparatus are controlled by the processor 72 in a similar way. For example, in the kiosk 300, shown in FIGS. 34, 35, and 36, the above arrangement of cold candle building may be utilised, or there may be a hot bath of wax, from which the processor 72 controls the dispensing into the container. This is shown in FIGS. 54, 55, 56, 57 and 58, where a container 23 is shown receiving liquid wax from a dispenser 30. In this arrangement, the reservoir 20 is surrounded by a heating jacket 29, and the wax in the cartridge 16 flows out the dispenser jets 31. A lid assembly 39 which includes a taper 9 fitted to a lid 38, is then mounted on the rim of the container 23 and the container is then cooled before release from the assembly zone 40. The camera 73 reader includes an IR function which identifies the temperature of the container 23. That data is sent to the processor 72 to causes the assembly zone door to be locked until the temperature is below a threshold.

A user may pay with a credit card or phone tap zone 368 or by inserting coins and/or notes in a slot 369. The processor 72 then causes the loader 50 to insert a taper into the warm bath of wax, as shown in FIG. 70. There is a lid dispenser (not shown) which the processor 72 causes to be loaded onto the container as shown in FIG. 70. The processor 72 causes the cooler to cool the container before it is released to the user.

The building cycle described above should take only a minute or two and then the user can then light the candle and then use the candle. This is a convenient way to build a tailored candle for a mood—select the desired taper scent then build up some fuel around it, and then burn it, without fuss or destroying the mood.

### Manual Tool and Kit

In FIGS. 60 to 62 there is shown a tool 85 for assembling a candle 25, and a kit of parts formed into the candle 25. The tool 85 is for driving a taper 9 into a bore of a wax block 8, the tool 85 including a handle 86 for gripping and operating the tool 85, a flange 87 disposed at a base 88 of the handle 86 for pressing down on the wax block 8, wherein the flange 87 includes a recess 89 for receiving a portion of the taper 9. The tool has a similar arrangement as the press 80 inside the housing 60 of the machine 10, but is totally manually operated.

To form the candle 25 with the tool and the kit, the user cuts out a fuel block from a cartridge 16 of the size which is about right for the container 23. The user may also stack pucks 4 to form a fuel pillar. The pucks 4 may be already bored with through holes 17, or the user may form one or more through holes 17 in the fuel block 8. Then, the user places one or more tapers 9 into the one or more holes 17 in the fuel block 8. The tool 85 then is fitted over the taper 9, which is received in the recess 89. The user then drives the tool downwards and then the taper 9 is driven into the bore 17. The recess 89 is an interference fit on the taper 9, or there may be a gripper or a clamp (not shown) in the recess 89 to hold the upper part of the taper 9. Therefore the tool 85 may be rotated which may then cause the taper 9 shown in FIG. 59 to be threaded into the bore 17.

The user may of course hand thread the taper 9 from FIG. 59 into the threaded bore 17.

The user may, alternatively, load the container with the taper 9, and sprinkle granular fuel into the container 23. The tool 85 is then pressed down and the candle 25 is formed.

A kit as shown in FIGS. 60 to 62, includes a container 25, a wax block in the form of a cartridge of pucks 4 or a solid block of wax fuel 6, a tool 85 and one or more tapers 9. There may also be a knife provided or a wire cutter for cutting the wax block into a suitable length.

### Clarifications

Modifications and improvements to the invention will be readily apparent to those skilled in the art. Such modifications and improvements are intended to be within the scope of this invention.

1-7. (canceled)

8. A candle assembly apparatus including:
a housing including an assembly zone in which to assemble a candle from solid fuel;
one or more reservoirs disposed in the housing for holding one or more fuel elements for assembling into a candle;
a dispenser for dispensing one or more fuel elements from the reservoir into the assembly zone to form a candle; and
a loader for loading one or more scented fuel plugs or scented tapers into the fuel stack in the assembly zone.

9. The candle assembly apparatus in accordance with claim 8 wherein the housing includes a closure for controlling access to the reservoir for loading fuel.

10. The candle assembly apparatus in accordance with claim 8 wherein the closure is a lid on a top of the housing.

11. The candle assembly apparatus in accordance with claim 8 wherein the housing includes a loading drawer operatively connected thereto, for loading a scented fuel plug or scented taper.

12. The candle assembly apparatus in accordance with claim 8 wherein the housing includes an assembly zone for assembling the fuel elements, or assembling the scented fuel plug or scented taper into the one or more fuel elements.

13. The candle assembly apparatus in accordance with claim 8 wherein the housing also includes an assembly zone loading drawer for loading a container into the housing to receive the one or more fuel elements and scented plug and scented taper.

14. The candle assembly apparatus in accordance with claim 8 wherein the housing includes a control system including a processor to control the candle assembly process.

15. The candle assembly apparatus in accordance with claim 8 wherein the reservoir includes a fuel magazine which includes one or more hollow tubes for receiving one or more fuel elements or cartridges.

16. The candle assembly apparatus in accordance with claim 8 wherein the loader includes a drawer for transporting the taper to the assembly zone.

17. The candle assembly apparatus in accordance with claim 8 wherein the loader includes a press for pressing the taper into the fuel elements.

18. The candle assembly apparatus in accordance with claim 8 wherein the processor includes an access control module for inhibiting access to unauthorised containers, the access control module including a reader which is configured to read data on a readable strip or tag.

19. The candle assembly apparatus in accordance with claim 8 wherein the dispenser includes a cutter for cutting a fuel element from the fuel cartridge.

20. The candle assembly apparatus in accordance with claim 8 wherein the reservoir includes a heating unit for heating an inside or the outside portion of the fuel elements in the reservoir for dispensing fuel into the container.
